(19) United States
(12) Patent Application Publication
(10) Pub. No.: US 2020/0363796 A1
(43) Pub. Date: Nov. 19, 2020

(54) CONTROL APPARATUS, WORK MACHINE, AND COMPUTER-READABLE STORAGE MEDIUM

(71) Applicant: HONDA MOTOR CO.,LTD., Tokyo (JP)

(72) Inventors: Keiji MURO, Saitama (JP); Naoki KAMEYAMA, Saitama (JP); Hideaki SHIMAMURA, Saitama (JP)

(21) Appl. No.: 16/986,301

(22) Filed: Aug. 6, 2020

Related U.S. Application Data
(63) Continuation of application No. PCT/JP2018/007655, filed on Feb. 28, 2018.

(51) Int. Cl. G05D 1/00; G05D 1/02

(52) U.S. Cl. CPC G05D 1/005; G05D 1/0219; G05D 1/0221; G05D 2201/0208; G05D 1/0223; G05D 1/0214; G05D 1/0044; G05D 1/0088

(57) ABSTRACT

Development of a technique with which a boundary of a work region can be identified by simple means is desired. A control apparatus that controls a work machine having an autonomous travel function includes a vibration information obtaining section configured to obtain, from a vibration detection section mounted to the work machine, vibration information related to the vibration detected by the vibration detection section, and a control section configured to control at least one of a progress direction, a progress speed, a travel mode, and a work mode of the work machine based on the vibration information obtained by the vibration information obtaining section.

The contents of the following international application are incorporated herein by reference:

NO. PCT/JP2018/007655 filed on Feb. 28, 2018.

### BACKGROUND

### 1. Technical Field

The present invention relates to a control apparatus, a work machine, and a computer-readable storage medium.

### 2. Related Art

In recent years, work machine has been developed which estimates a self-location using a GPS signal and autonomously travels inside a predetermined region (which may be referred to as a work region in some cases). (For example, see Patent Literature 1 or 2).

### CITATION LIST

### Patent Literature

[Patent Literature 1] Japanese Unexamined Patent Application Publication No. 2016-185099

[Patent Literature 2] Japanese Unexamined Patent Application Publication No. 2013-223531

The summary clause does not necessarily describe all necessary features of the embodiments of the present invention. The present invention may also be a sub-combination of the features described above.

### BRIEF DESCRIPTION OF THE DRAWINGS

FIG. 1 schematically illustrates one example of an internal configuration of a work machine 150.

FIG. 2 schematically illustrates one example of a system configuration of a management system 200.

FIG. 3 schematically illustrates one example of an internal configuration of a lawn mower 210.

FIG. 4 schematically illustrates one example of an internal configuration of a control unit 380.

FIG. 5 schematically illustrates one example of an internal configuration of a control parameter decision section 450.

FIG. 6 schematically illustrates one example of an internal configuration of a change judging section 510.

FIG. 7 schematically illustrates one example of a method for controlling an operation of the lawn mower 210.

FIG. 8 schematically illustrates one example of a situation when the lawn mower 210 enters a boundary.

FIG. 9 schematically illustrates one example of vibration data when the lawn mower 210 enters the boundary.

FIG. 10 schematically illustrates one example of an internal configuration of a management server 230.

FIG. 11 schematically illustrates one example of an internal configuration of a map management section 1030.

FIG. 12 schematically illustrates one example of a setting screen 1200.

### DESCRIPTION OF EXEMPLARY EMBODIMENTS

Hereinafter, the present invention will be described by way of exemplary embodiments of the invention, but the following embodiments are not intended to restrict the invention according to the claims. In addition, not all combinations of features described in the embodiments necessarily have to be essential to solving means of the invention. It is noted that in the drawings, the same or similar parts are assigned with the same reference signs, and redundant descriptions may be omitted in some cases. In addition, as long as a technically significant contradiction is not made, two or more elements that have the same name and are assigned with different reference signs may respectively have mutually similar configurations.

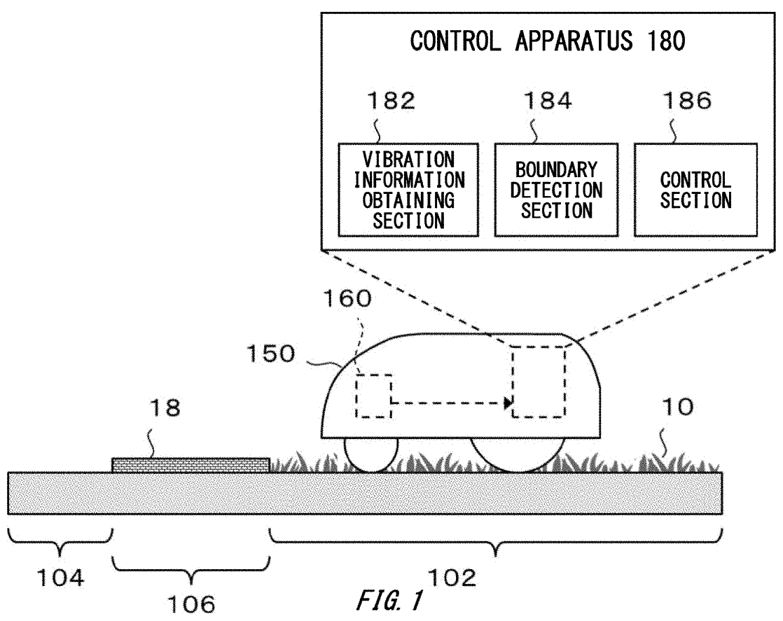

FIG. 1 schematically illustrates one example of an internal configuration of a work machine 150. FIG. 1 schematically illustrates one example of an internal configuration of a control apparatus 180. According to the present embodiment, the work machine 150 includes, for example, a vibration detection section 160 and the control apparatus 180. The work machine 150 may also include a plurality of vibration detection sections 160. According to the present embodiment, the control apparatus 180 includes, for example, a vibration information obtaining section 182, and at least one of a boundary detection section 184 and a control section 186.

For the sake of simplicity of descriptions, according to the present embodiment, while a case where the work machine 150 detects a boundary 106 between a work region 102 and a non-work region 104 is used as an example, a detail of the work machine 150 will be described. In addition, while a case where the work machine 150 changes at least one of a progress direction, a progress speed, a travel mode, and a work mode in the vicinity of the boundary 106 between the work region 102 and the non-work region 104 is used as an example, the detail of the work machine 150 will be described. However, note that the work machine 150 is not limited to the present embodiment.

According to the present embodiment, the work region 102 is a region in which the work machine 150 performs a particular work. The work region 102 may also be a region in which the work machine 150 is permitted to perform the particular work. According to the present embodiment, the non-work region 104 is a region in which the work machine 150 does not perform the particular work. The non-work region 104 may also be a region in which the work machine 150 is prohibited from performing the particular work.

According to the present embodiment, a plant 10 corresponding to a target of the work grows in the work region 102. On the other hand, the plant 10 corresponding to the target of the work does not grow in the non-work region 104. In accordance with the present embodiment, a state of a surface of the work region 102 is different from a state of a surface of the non-work region 104. For this reason, a vibration state of the work machine 150 differs in a case where the work machine 150 travels in the work region 102 and a case where the work machine 150 travels in the non-work region 104.

According to the present embodiment, the boundary 106 separates an inside and an outside of a particular region. For example, the boundary 106 separates an inside and an outside of the work region 102. The non-work region 104 may be one example of an outside region of the work region 102. According to the present embodiment, a boundary identification member 18 for assisting detection or identification of the boundary 106 by the work machine 150 is arranged in the boundary 106 between the work region 102 and the non-work region 104. For example, when the work machine 150 detects the boundary identification member 18, it is possible to distinguish the inside and the outside of the work region 102. The work machine 150 may also distinguish the work region 102, the non-work region 104, and the boundary 106. According to another embodiment, the work machine 150 can distinguish types of the boundary 106. For example, the work machine 150 (i) identifies a type of the boundary 106, and (ii) decides an operation in the boundary 106 on the basis of the type of the boundary 106.

According to the present embodiment, the boundary identification member 18 is arranged on the boundary 106, and a state of a surface of the boundary 106 is maintained as a different state from a state of the surface of the work region 102. The boundary identification member 18 may also maintain the state of the surface of the boundary 106 as a different state from states of the surfaces of the work region 102 and the non-work region 104. In the boundary identification member 18, the state of the surface may be a material different from the state of the surface of the work region 102. As the state of the surface, hardness of the surface, transmissibility of the vibration, roughness of the surface, and the like are exemplified.

According to one embodiment, as the boundary identification member 18, various pavement materials are used. As the pavement materials, soil, clay, sand, gravel, pebble, a brick, concrete, asphalt, a block, a plate, a coating film, a pelletized substance, a granular substance, a gelatinous substance, and the like are exemplified. A material of the block, the plate, the coating film, the pelletized substance, and the granular substance may also be a resin material, may also be a wood material, may also be a stone material, and may also be a metallic material. Irregularities having a particular shape may be artificially formed on surfaces of the brick, the block, and the plate. According to another embodiment, as the boundary identification member 18, a plant, mosses, a fungus, a slime mold, bacteria, and the like are used. According to still another embodiment, as the boundary identification member 18, a fluid may also be splayed on the boundary 106.

According to the present embodiment, the boundary identification member 18 is installed such that at least a part of the boundary identification member 18 is located on a surface of a ground. Thus, as compared with a case where the whole of the boundary identification member 18 is buried in the ground, installation of the boundary identification member 18 and discovery and maintenance and repair of a damaged part are facilitated. In addition, up to now, in a case where an electric field generated by applying a voltage to both ends of a conductive wire buried in the ground is used for the detection of the boundary, when a part of the wire is severed by a small animal, aging, or the like, it has been difficult for the work machine 150 to detect the boundary. In contrast, even in a case where a part of the boundary identification member 18 is damaged, the work machine 150 can detect the boundary.

[Outline of Work Machine 150]

According to the present embodiment, the work machine 150 has an autonomous travel function. The work machine 150 may control movement of the work machine 150 according to a state of a surrounding environment of the work machine 150. For example, the work machine 150 decides whether to continue the straight-ahead progress, whether to change the progress direction, whether to interrupt the progress and make a turn, whether to change the progress speed, and the like according to the state of the surrounding environment of the work machine 150. The work machine 150 may also have a self-location estimation function. The work machine 150 may also decide a route by referring to map information.

For example, the work machine 150 autonomously moves inside the work region 102. It may be determined whether entry to the non-work region 104 is permitted in the vicinity of the boundary 106 of the work region 102. For example, in a case where the boundary 106 between the work region 102 and the non-work region 104 is detected, the work machine 150 determines whether the entry to the non-work region 104 is permitted.

In a case where the entry to the non-work region 104 is permitted, the work machine 150 may pass through the boundary 106 to enter the non-work region 104. On the other hand, in a case where the entry to the non-work region 104 is not permitted or the entry to the non-work region 104 is prohibited, the work machine 150 turns in the vicinity of the boundary 106, for example, and resumes the progress towards the inside of the work region 102. In a case where the entry to the non-work region 104 is not permitted or a case where the entry to the non-work region 104 is prohibited, the work machine 150 may turn in the vicinity of the boundary 106 and resume the progress along the boundary 106.

According to the present embodiment, the work machine 150 performs the particular work inside the work region 102. On the other hand, the work machine 150 stops or interrupts the above-described work in the non-work region 104. The work machine 150 autonomously moves inside the work region 102, for example, and performs a predetermined work.

The work machine 150 may control the work of the work machine 150 according to the state of the surrounding environment of the work machine 150. For example, the work machine 150 decides start of the work, interruption of the work, stop of the work, a type of the work, an intensity of the work, and the like according to the state of the surrounding environment of the work machine 150. The type of the work performed by the work machine 150 is not particularly limited. As the type of the work, (i) civil engineering work, (ii) construction work, (iii) cultivation work for plant or agricultural product, (iv) snow clearing work, (v) cleaning work, (vi) transport work, (vii) monitoring, guard duty, or security work, and the like are exemplified. As the cultivation work, sowing, pruning, lawn mowing, grass cutting, watering, fertilizing, soiling, weeding, and the like are exemplified.

According to the present embodiment, an operation of the work machine 150 is controlled on the basis of a vibration state of the work machine 150. The vibration state of the work machine 150 changes according to the state of the surface of the ground in contact with the work machine 150. Since the state of the surface of the ground changes in the vicinity of the boundary 106, according to the present embodiment, with the simple configuration, it is possible to control the operation of the work machine 150 in the vicinity of the boundary 106. A detail of a method of controlling the operation of the work machine 150 will be described below.

According to the present embodiment, the vibration detection section 160 is arranged in the work machine 150, and detects the vibration of the work machine 150. The vibration detection section 160 may detect vibration of a vehicle body of the work machine 150. The vibration detection section 160 may also detect vibration of wheels or a continuous track of the work machine 150. The vibration detection section 160 is disposed, for example, in at least one of (i) the vehicle body, (ii) the wheels or the continuous track, (iii) an axle, and (iv) a suspension apparatus of the work machine 150.

According to one embodiment, at least one of the vibration detection sections 160 is disposed in a location in front of a center of gravity or a center of the work machine 150. According to another embodiment, at least one of the vibration detection sections 160 is disposed in a location where a distance between the vibration detection section 160 and an outer peripheral part of the work machine 150 is larger than a distance between the vibration detection section 160 and the center of gravity or the center of the work machine 150. According to still another embodiment, at least one of the vibration detection sections 160 is disposed in a location where a distance between the vibration detection section 160 and the wheels or the continuous track of the work machine 150 is smaller than the distance between the vibration detection section 160 and the center of gravity or the center of the work machine 150. According to still another embodiment, at least two vibration detection sections 160 is disposed in a location symmetrical to a central axis extending in a front-and-back direction of the vehicle body through the center of the vehicle body of the work machine 150.

As the vibration detection section 160, a gyro sensor, an acceleration sensor, a combination of these, and the like are exemplified. The gyro sensor may also be a uniaxial gyro sensor, may also be a biaxial gyro sensor, or may also be a triaxial gyro sensor. The gyro sensor preferably outputs at least one of an angular velocity and an angular acceleration related to at least one axis among a roll axis (axis extending in the front-and-back direction of the vehicle body), a pitch axis (axis extending in a left-and-right direction of the vehicle body), and a yaw axis (axis extending in the up-and-down direction of the vehicle body). The gyro sensor may also output a component of at least one of the angular velocity and the angular acceleration of the work machine 150 in a vertical direction. The acceleration sensor may also be a uniaxial acceleration sensor, may also be a biaxial acceleration sensor, or may also be a triaxial acceleration sensor. The acceleration sensor may also output a component of the acceleration of the work machine 150 in the vertical direction.

According to the present embodiment, the control apparatus 180 controls the work machine 150. More specifically, the control apparatus 180 controls the operation of the work machine 150. As the operation of the work machine 150, an operation associated with the movement of the work machine 150, an operation associated with the work of the work machine 150, and the like are exemplified.

According to one embodiment, the control apparatus 180 controls at least one of the progress direction, the progress speed, the travel mode, and the work mode of the work machine 150 on the basis of information related to the vibration detected by the vibration detection section 160 (which may be referred to as vibration data in some cases). According to another embodiment, the control apparatus 180 detects the boundary 106 on the basis of the vibration data. In a case where the boundary 106 is detected, the control apparatus 180 may also control at least one of the progress direction, the progress speed, the travel mode, and the work mode of the work machine 150.

It is noted that the work machine 150 may also detect the boundary 106 on the basis of data output from at least one of an internal sensor and an external sensor mounted to the work machine 150. For example, the work machine 150 (i) estimates a location of the work machine 150, and (ii) detects the boundary 106 on the basis of the map information including location information of the boundary 106. The work machine 150 may also estimate a self-location on the basis of the data output from the at least one of the internal sensor and the external sensor mounted to work machine 150. The work machine 150 may also detect the boundary 106 on the basis of the vibration data output by the vibration detection section 160 and data output from at least one of another internal sensor and another external sensor mounted to the work machine 150.

According to the present embodiment, the travel mode regulates at least one of (i) a travel pattern, and (ii) an interval of travel paths. As the travel pattern, (i) a pattern for travelling on a path in which locational coordinates of a plurality of points are predetermined, (ii) a pattern for travelling on a path in which a shape and a size of the path are regulated by a predetermined function, (iii) a pattern for travelling along the boundary of the work region, (iv) a pattern for travelling along a path that has a shape similar to a boundary shape of the work region, (v) a pattern for travelling on a path that has a spiral shape oriented from a boundary side of the work region towards a central side (the shape of the spiral is not particularly limited), (vi) a pattern for travelling on a path that has a spiral shape oriented from the central side of the work region towards the boundary side (the shape of the spiral is not particularly limited), (vii) a pattern for travelling on a path that has a zigzag shape, (viii) a pattern for travelling on a path that has a rectangular wave-like shape, (ix) a travel pattern for, after arriving any boundary, turning in a direction decided based on any probability model (for example, a direction that has been randomly decided) and continuing travelling, (x) a pattern for travelling by repeating straight-ahead progress and turning such that a plurality of parallel paths are disposed without a gap or at a predetermined gap, and the like are exemplified.

According to the present embodiment, the work mode regulates at least one of (i) whether the work can be performed, and (ii) the work intensity. As the work mode, (i) a mode in which the work is performed on the move, (ii) a mode in which the work is stopped or interrupted during the movement, (iii) a mode in which the work is performed during the straight-ahead progress, but the work is stopped or interrupted during a turning operation, and the like are exemplified. As other examples of the work mode, (i) a mode in which the work intensity is relatively large, (ii) a mode in which the work intensity is intermediate, (iii) a mode in which the work intensity is relatively small, and the like are exemplified.

As the work intensity, a work frequency in a particular period, a work amount per work, a total work amount in a particular period, and the like are exemplified. The work intensity may also be represented by consecutive numerical values, or may also be represented by graded classifications. Each classification may also be distinguished by a symbol or a character, or may also be distinguished by a number.

As other examples of the work mode, (iv) a mode for returning to a home station, (v) a mode for moving from the home station to a work-starting location of an intended work, and the like are exemplified. The home station may be a standby location or a storage location for the work machine 150. A replenishment device configured to replenish energy or consumables to the work machine 150 may be disposed in the home station. The home station may also be disposed inside the work region of the work machine 150, or may also be disposed outside the work region.

According to the present embodiment, the vibration information obtaining section 182 obtains the vibration data from the vibration detection section 160. The vibration data may be information in which information indicating a time is associated with information indicating a magnitude of the vibration at the time. In a case where the work machine 150 includes the plurality of vibration detection sections 160, the vibration information obtaining section 182 may obtain the vibration data output by each of the plurality of vibration detection sections 160. The vibration information obtaining section 182 may transmit the above-described vibration data to the boundary detection section 184. The vibration information obtaining section 182 may transmit the above-described vibration data to the control section 186.

According to the present embodiment, the boundary detection section 184 detects the boundary 106 between the work region 102 and the non-work region 104 on the basis of the vibration data obtained by the vibration information obtaining section 182. The boundary detection section 184 may also receive the vibration data output from one or a plurality of vibration detection sections 160, and output information indicating whether the boundary 106 is detected. The information indicating whether the boundary 106 is detected may also be information indicating that the boundary 106 is detected.

The boundary detection section 184 may also receive the vibration data output from the one or a plurality of vibration detection sections 160, and output the information indicating the type of the boundary 106. The boundary detection section 184 may also output information indicating the operation of the work machine 150 corresponding to the type of the boundary 106. For example, the boundary detection section 184 receives the vibration data output from the one or a plurality of vibration detection sections 160 and outputs information indicating whether the progress may be continued, information indicating that the progress direction is changed while the progress is continued, information indicating that the progress is interrupted to make a turn, information indicating that the movement along the boundary 106 is performed, information indicating that the progress speed is changed, information indicating that the travel mode is changed, information indicating that the work mode is changed, and the like.

According to the present embodiment, the control section 186 controls at least one of the progress direction, the progress speed, the travel mode, and the work mode of the work machine 150 on the basis of the vibration data obtained by the vibration information obtaining section 182. The control section 186 may receive the vibration data output from the one or a plurality of vibration detection sections 160, and output a command for changing at least one of the progress direction, the progress speed, the work mode, and the travel mode of the work machine 150. For example, the control section 186 receives the vibration data output from the one or a plurality of vibration detection sections 160 and outputs the information indicating whether the progress may be continued, the information indicating that the progress direction is changed while the progress is continued, the information indicating that the progress is interrupted to make a turn, the information indicating that the movement along the boundary 106 is performed, the information indicating that the progress speed is changed, the information indicating that the travel mode is changed, the information indicating that the work mode is changed, and the like.

The control section 186 may also control at least one of the progress direction, the progress speed, the travel mode, and the work mode of the work machine 150 on the basis of the data that has been output by the boundary detection section 184 on the basis of the vibration data obtained by the vibration information obtaining section 182. According to one embodiment, in a case where the boundary detection section 184 detects the boundary 106, the control section 186 outputs a command for changing at least one of the progress direction, the progress speed, the travel mode, and the work mode of the work machine 150. According to another embodiment, the control section 186 outputs a command for changing at least one of the progress direction, the progress speed, the travel mode, and the work mode of the work machine 150 on the basis of the information indicating the type of the boundary 106 which is included in the output data of the boundary detection section 184. According to still another embodiment, the control section 186 outputs a command for changing at least one of the progress direction, the progress speed, the travel mode, and the work mode of the work machine 150 on the basis of the information indicating the operation of the work machine 150 which is included in the output data of the boundary detection section 184.

As described above, according to the present embodiment, the control apparatus 180 controls at least one of the progress direction, the progress speed, the travel mode, and the work mode of the work machine 150 on the basis of the information related to the vibration of the work machine 150. In addition, the control apparatus 180 detects the boundary 106 on the basis of the vibration data. Thus, the control apparatus 180 can control the operation of the work machine 150 in the vicinity of the boundary 106.

Up to now, to control an operation of work machine in the boundary of the work region, a conductive wire for generating an artificial magnetic field is buried in the boundary, and detailed map information indicating the boundary of the work region is created. However, when a part of the wire is severed, a current does not flow through the wire, and an issue occurs that the work machine does not recognize the boundary at all. In addition, for example, when a region where the positioning precision based on the GPS signal is low exists in the vicinity of the boundary of the work region, an estimation precision of the self-location in the vicinity of the boundary of the work region decreases. When the estimation precision of the self-location decreases, an issue occurs that the detection of the boundary using the map information indicating the boundary of the work region becomes difficult. In addition, in the first place, it takes a large amount of labor to create the map information indicating the boundary of the work region for itself.

In contrast, according to the present embodiment, even in a case where a part of the boundary identification member 18 disposed on the boundary 106 is damaged, the control apparatus 180 can detect the boundary 106 and control the operation of the work machine 150 in the vicinity of the boundary 106. In addition, even in a case where the boundary identification member 18 is not disposed on the boundary 106, the control apparatus 180 can detect the boundary 106 and control the operation of the work machine 150 in the vicinity of the boundary 106.

Furthermore, even in a case where information indicating the estimated location of the work machine 150 is not usable, the control apparatus 180 can detect the boundary 106 and control the operation of the work machine 150 in the vicinity of the boundary 106. It is noted that the control apparatus 180 may also detect the boundary 106 and control the operation of the work machine 150 in the vicinity of the boundary 106 on the basis of the information indicating the estimated location of the work machine 150 and the information indicating the vibration state of the work machine 150.

According to the present embodiment, a detail of the control apparatus 180 has been described while the embodiment is used as an example in which the boundary identification member 18 is disposed on the boundary 106, and the control apparatus 180 detects the boundary identification member 18, so that the boundary 106 is detected, and the operation of the work machine 150 in the vicinity of the boundary 106 is controlled. However, the control apparatus 180 is not limited to the present embodiment. According to another embodiment, a configuration may also be adopted where the boundary identification member 18 is not disposed between the work region 102 and the non-work region 104, and the work region 102 and the non-work region 104 are adjacent to each other.

In this case too, the control apparatus 180 can detect the boundary 106 and control the operation of the work machine 150 in the vicinity of the boundary 106 on the basis of a difference between (i) the state of the surface of the work region 102 and (ii) the state of the surface of the non-work region 104. For example, the control apparatus 180 can detect the boundary 106 and control the operation of the work machine 150 in the vicinity of the boundary 106 on the basis of a difference between (i) a vibration pattern of the vibration detected by the vibration detection section 160 when the work machine 150 travels in the work region 102, and (ii) a vibration pattern of the vibration detected by the vibration detection section 160 when the work machine 150 travels in the non-work region 104.

In addition, according to the present embodiment, the detail of the control apparatus 180 has been described while the embodiment in which the control apparatus 180 is mounted to the work machine 150 is used as an example. However, the control apparatus 180 is not limited to the present embodiment. According to another embodiment, the control apparatus 180 may be disposed outside the work machine 150. The control apparatus 180 may also be an information processing apparatus that can transmit and receive information with the work machine 150 via a communication network, and may also be realized by the information processing apparatus.

[Specific Configuration of Each Portion of Work Machine 150]

Each portion of the work machine 150 may also be realized by hardware, may also be realized by software, or may also be realized by hardware and software. In a case where at least a part of components constituting the work machine 150 (for example, the control apparatus 180) is realized by software, the component realized by the software may be realized by activating a program that regulates the operation related to the component in an information processing device having a general configuration.

The above-described information processing device may include (i) a data processing device having processors such as a CPU or a GPU, a ROM, a RAM, a communication interface, and the like, (ii) input devices such as a keyboard, a touch panel, a camera, a microphone, various types of sensors, and a GPS receiver, (iii) output devices such as a display device, a speaker, and a vibration device, and (iv) storage devices (including external storage devices) such as a memory and a HDD. In the above-described information processing device, the above-described data processing device or storage device may store the above-described program. The above-described program causes the information processing device described above to perform the operations regulated by this program, by being executed by the processor. The above-described program may also be stored in a non-transitory computer-readable recording medium.

The above-described program may be a program that causes a computer to function as the control apparatus 180. The above-described computer may also be a computer that provides a cloud service, or may also be a computer that realizes a client-server system. The above-described computer may also be (i) a computer mounted to the work machine 150, or may also be (ii) a computer that serves as an external computer of the work machine 150 and controls the work machine 150 via the communication network.

The above-described program may also be a program that causes a computer to execute one or a plurality of procedures related to various types of information processing in the control apparatus 180. One or a plurality of procedures related to various types of information processing in the control apparatus 180 may also be procedures for controlling for the work machine 150. The procedures for controlling the work machine 150 have, for example, a vibration information obtaining step for obtaining vibration information related to the vibration detected by the vibration detection section 160 from the vibration detection section 160 mounted to the work machine 150. The above-described control method has, for example, a control step for controlling at least one of the progress direction, the progress speed, the travel mode, and the work mode of the work machine 150 on the basis of the vibration information obtained in the vibration information obtaining step. The above-described control method has, for example, a boundary detection step for detecting the boundary 106 between the work region 102 and the non-work region 104 of the work machine 150 on the basis of the vibration information obtained in the vibration information obtaining step.

[Outline of Management System 200]

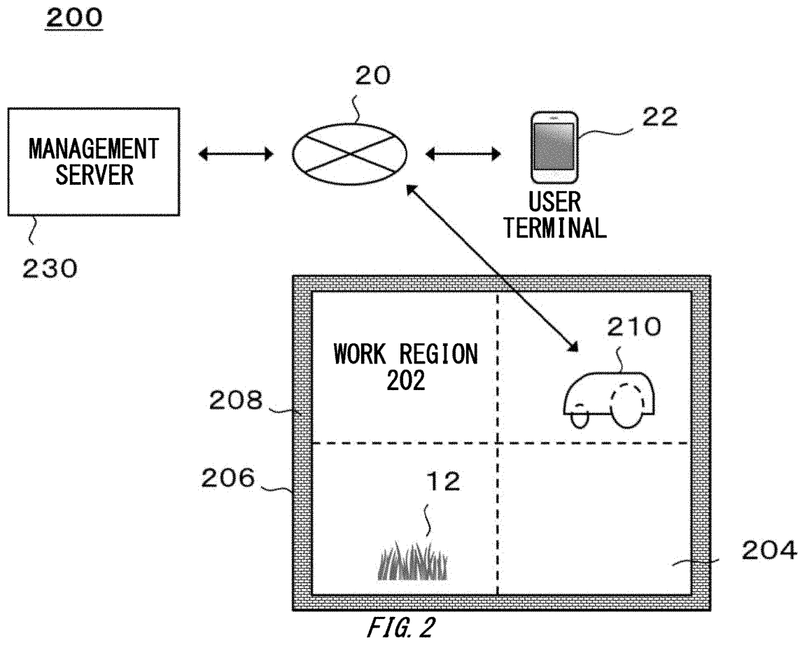

FIG. 2 schematically illustrates one example of a system configuration of a management system 200. According to the present embodiment, the management system 200 includes one or a plurality of lawn mowers 210, and a management server 230. The management system 200 may also include one or a plurality of user terminals 22. The lawn mower 210 may be one example of the work machine. A computer of the lawn mower 210 may be one example of the control apparatus.

According to the present embodiment, for the sake of simplicity of descriptions, a detail of the management system 200 will be described while a case is used as an example where the lawn mower 210 has an autonomous movement function, and the computer mounted to the lawn mower 210 controls an operation of the lawn mower 210. However, the management system 200 is not limited to the present embodiment. According to another embodiment, at least one of the user terminal 22 and the management server 230 may also control the operation of the lawn mower 210. In this case, at least one of the user terminal 22 and the management server 230 may be one example of the control apparatus.

According to the present embodiment, a work for growing the lawn 12 is performed inside a work region 202. The lawn 12 may be one example of a plant or an agricultural product. A location and a range of the work region 202 are not particularly limited. The range of the region may represent a size and a shape of the region. The work region 202 may have any geographical range. The work region 202 may have a predetermined geographical range. As the type of the work for growing the lawn 12, sowing, pruning, lawn mowing, grass cutting, watering, fertilizing, soiling, weeding, and the like are exemplified. In accordance with the present embodiment, the lawn mower 210 that has the autonomous travel function performs lawn mowing by moving inside the work region 202.

According to the present embodiment, a plurality of the sub areas 204 is included inside the work region 202. Each of the sub areas 204 may also be a region which is separated by a physical geographical boundary or may also be a region which is separated by a virtual geographical boundary.

As the physical geographical boundary, (i) a boundary defined by a structure that has been naturally or artificially formed, (ii) a boundary defined by sprayed chemicals, (iii) a boundary defined by an electromagnetic wave such as visible light, infrared light, ultraviolet light, and the like, (iv) a boundary defined by a magnetic field, (v) a boundary defined by an acoustic wave or an ultrasonic sound wave, and the like are exemplified. As the naturally formed structure, a dent, a step, a slope, a lake, a river, and the like are exemplified. As the artificially formed structure, a lane, a groove, a tunnel, a building, a wire, a rope, a fence, a net, a Braille block, and the like are exemplified. As the virtual geographical boundary, a geofence, a virtual wire, and the like are exemplified. The virtual wire may be a geographical boundary defined by a virtual line set between a plurality of structures.

The number of the sub areas 204 included inside the work region 202, and a size and a shape of the sub area 204 are not particularly limited. However, the plurality of sub areas 204 is preferably uniformly arranged inside the work region 202 to avoid the absence of the arrangement and the overlapped arrangement. The respective sizes of the plurality of sub areas 204 may also be the same, or may also be different from each other. The respective shapes of the plurality of sub areas 204 may also be the same, or may also be different from each other.

The number of the sub areas 204 disposed inside the work region 202 may also be fixed, or may also be variable. For example, the number of the sub areas 204 disposed in a particular region that constitutes a part of the work region 202 is changed when occurrence of a predetermined event is used as a trigger. Specifically, a plurality of the sub areas 204 that are disposed adjacent to each other may also be virtually combined to form a single sub area 204. The single sub area 204 may also be virtually divided into a plurality of the sub areas 204 that are disposed adjacent to each other. The number of the sub areas 204 disposed in the particular region inside the work region 202 may also be adjusted according to a required precision.

According to the present embodiment, tiles 208 are disposed on a boundary 206 that separates the inside and the outside of the work region 202. The outside of the work region 202 may be one example of the non-work region. A material of each of the tiles 208 is selected such that a vibration state of the lawn mower 210 varies in a case where the lawn mower 210 travels on the lawn 12 and in a case where the lawn mower 210 travels on the tiles 208. An artificial irregularity pattern may also be formed on a surface of the tiles 208.

According to the present embodiment, for the sake of simplicity of descriptions, a detail of the boundary 206 will be described while a case where the single boundary 206 is formed along an outer periphery of the work region 202 is used as an example. However, the boundary 206 is not limited to the present embodiment. According to another embodiment, the work region 202 may also be defined by a plurality of the boundaries 206, and one or a plurality of the boundaries 206 may be formed inside the work region 202. For example, in a case where the work region 202 includes two regions that are geographically away from each other, the work region 202 is defined by the plurality of boundaries 206. In addition, for example, in a case where an obstacle, a facility, an apparatus, and the like (which as referred to as obstacles and the like in some cases) exist inside the work region 202, the work region 202 is defined by the first boundary 206 that defines an outer edge of the work region 202 and the second boundary 206 that defines the obstacles and the like.

A vibration pattern that appears in a case where the lawn mower 210 travels on the tiles 208 is decided by the material and the irregularity pattern of the tiles 208. For this reason, when a user of the lawn mower 210 selects at least one of the material and the irregularity pattern of the tiles 208, it is possible to control the operation of the lawn mower 210 in the vicinity of the boundary 206.

The vibration pattern may also be identified by a learning machine that has already performed learning, or may also be identified following a predetermined analysis procedure. The vibration pattern is identified, for example, on the basis of at least one of a frequency, an amplitude, and a phase of the vibration waveform.

According to one embodiment, the vibration pattern is identified by a frequency distribution of the vibration waveform. The vibration pattern is identified, for example, on the basis of a distribution shape of the frequency distribution. The vibration pattern may also be identified by pattern recognition of the distribution shape of the frequency distribution, or may also be identified by whether vibrations at one or a plurality of particular frequencies are included. The vibration pattern may also be identified on the basis of a value of at least one frequency of one or a plurality of peaks that appear in the frequency distribution of the vibration waveform. The vibration pattern may also be identified on the basis of a ratio of spectrum intensities of the plurality of peaks.

According to another embodiment, the vibration pattern is identified by an appearing pattern of vibration at one or a plurality of particular frequencies. When a temporal change of the frequency distribution is observed, appearance and disappearance of the vibration at the particular frequency may be repeated in some cases. The vibration pattern may be identified on the basis of at least one of a frequency, an amplitude, and a phase of the appearing pattern of the vibration at the particular frequency.

According to still another embodiment, the vibration pattern is identified by a magnitude of the vibration. For example, the vibration pattern is identified by at least one of an average value, a median value, or a mode value of magnitudes of vibration sampled in a predetermined period. A threshold for identifying each of a plurality of vibration patterns may also be decided according to a travelling speed of the lawn mower 210 at the time of the sampling.

According to still another embodiment, the vibration pattern is identified by an intermittent pattern of the vibration. When a temporal change of the vibration waveform is observed, the intermittent pattern may appear in some cases since a timing when the magnitude of the vibration exceeds a particular threshold and a timing when the magnitude of the vibration is below the threshold are repeated. The vibration pattern may be identified on the basis of at least one of a frequency, an amplitude, and a phase of the intermittent pattern.

The single boundary 206 may also be formed by the tiles 208 of a single type, or may also be formed by the tiles 208 of a plurality of types. More specifically, at least one of (i) the material and (ii) the irregularity pattern formed on the surface of the tiles 208 may also differ in the tiles 208 disposed at a first spot on the boundary 206 and the tiles 208 disposed at a second spot on the boundary 206. The first spot and the second spot may also be geographically away from each other.

In a case where the single boundary 206 is formed by the tiles 208 of the plurality of types, the single boundary 206 may also include boundaries of a plurality of types. Even in a case where the single boundary 206 is also formed of the tiles 208 of the plurality of types, the types of the boundaries represented by the tiles 208 of the plurality of types may also be the same.

As the type of the boundary, (i) a boundary indicating that the progress of the lawn mower 210 is prohibited in a region ahead of the boundary, (ii) a boundary indicating that the progress of the lawn mower 210 is permitted in the region ahead of the boundary, (iii) a boundary for sending a particular command to the lawn mower 210, and the like are exemplified. As the particular command, a command for instructing that the progress is to be made in a particular direction, a command for instructing that the travel is to be performed at a particular speed, a command for instructing that the travel is to be performed in a particular travel mode, a command for instructing that a particular work is to be started or stopped, and the like are exemplified.

As long as a technical contradiction is not made, the boundary 206 may have a configuration similar to the boundary 106. Similarly, as long as a technical contradiction is not made, the boundary 106 may also have a configuration similar to the boundary 206. The tile 208 may be one example of the boundary identification member 18. As long as a technical contradiction is not made, the tile 208 may have a configuration similar to the boundary identification member 18. Similarly, as long as a technical contradiction is not made, the boundary identification member 18 may also have a configuration similar to the tile 208.

Each portion of the management system 200 may also mutually transmit and receive information. For example, the lawn mower 210 transmits and receives the information with at least one of the user terminal 22 and the management server 230 via a communication network 20.

According to the present embodiment, the communication network 20 may also be a wired communication transmission path, may also be a wireless communication transmission path, or may also be a combination of a wireless communication transmission path and a wired communication transmission path. The communication network 20 may also include a wireless packet communication network, the Internet, a P2P network, a dedicated line, a VPN, a power line communication link, and the like. The communication network 20 may also include (i) a mobile communication network such as a mobile phone line network, or may also include (ii) a wireless communication network such as a wireless MAN (for example, WiMAX (registered trademark)), a wireless LAN (for example, WiFi (registered trademark)), Bluetooth (registered trademark), Zigbee (registered trademark), or NFC (Near Field Communication).

According to the present embodiment, the user terminal 22 is a communication terminal used by a user of the management system 200 or the lawn mower 210, and a detail thereof is not particularly limited. As the user terminal 22, a personal computer, a mobile terminal, and the like are exemplified. As the mobile terminal, a mobile phone, a smartphone, a PDA, a tablet, a notebook computer, a laptop computer, a wearable computer, and the like are exemplified.

According to the present embodiment, the management system 200 manages the work region 202. For example, the management system 200 may also manage a state of an object (which may be referred to as a work target in some cases) on which a work is to be performed in the work region 202. The lawn 12 may be one example of the work target. The management system 200 may also manage the work performed in the work region 202. For example, the management system 200 manages a schedule of the work. The schedule of the work may be information that defines at least one of a time when the work is performed, a location where the work is performed, an entity which performs the work, the work target, and contents of the work.

According to the present embodiment, the management system 200 manages the lawn mower 210. The lawn mower 210 may be one example of the entity which performs the work. For example, the management system 200 manages the state of the lawn mower 210. For example, the management system 200 manages the location of the lawn mower 210, the progress direction, the progress speed, the travel mode, the work mode, the energy remaining amount (for example, the remaining amount of a battery), the schedule of the work performed by the lawn mower 210, and the like.

[Outline of Each Portion of Management System 200]

According to the present embodiment, the lawn mower 210 has an autonomous travel function. According to the present embodiment, the lawn mower 210 autonomously travels inside the work region 202. It is noted that the lawn mower 210 may also be moved by a remote operation by the user. The lawn mower 210 cuts the lawn 12 that grows in the work region 202. The lawn mower 210 may also travel while cutting the lawn 12, or may also travel without cutting the lawn 12. A detail of the lawn mower 210 will be described below.

The lawn mower 210 may be one example of the work machine (which may also be referred to as work machine in some cases). The work machine is not limited to the lawn mower 210. The work machine may also be a moving body that travels on land, may also be a moving body that flies in the air, or may also be a moving body that navigates under water or on water. As another example of the work machine, a drone, a helicopter, an airship, and the like that fly in the air are exemplified. The above-described work machine may also have the autonomous movement function. In a case where the work machine is controlled on the basis of the vibration information of the work machine, the work machine is preferably a moving body that travels on land.

According to the present embodiment, the management server 230 manages various information related to the work region 202. For example, the management server 230 manages geographical information related to the work region 202 (which may be referred to as map information in some cases). According to one embodiment, the management server 230 manages the information indicating the location of the boundary 206 related to the work region 202. The management server 230 according to another embodiment manages information in which the information indicating the particular spot on the boundary 206 or the location of the region is associated with the information indicating the type of the boundary at the spot or in the region. According to still another embodiment, manages information in which the information indicating the particular spot on the boundary 206 or the location of the region is associated with the information indicating the contents of the operation of the lawn mower 210 at the spot or in the region.

The management server 230 may manage the states of the apparatuses constituting the management system 200. The management server 230 may also control the operations of the apparatus constituting the management system 200. The management server 230 may also manage a growing state of the lawn 12. The management server 230 may also manage various works performed in the work region 202. For example, the management server 230 creates schedules of the above-described various works. The management server 230 may also manage progresses of the schedules of the above-described various works. A detail of the management server 230 will be described below.

[Specific Configuration of Each Portion of Management System 200]

Each portion of the management system 200 may also be realized by hardware, may also be realized by software, or may also be realized by hardware and software. At least a part of each portion of the management system 200 may also be realized by a single server, or may also be realized by a plurality of servers. At least a part of each portion of the management system 200 may also be realized on a virtual server or a cloud system. At least a part of each portion of the management system 200 may also be realized by a personal computer or a mobile terminal. As the mobile terminal, a mobile phone, a smartphone, a PDA, a tablet, a notebook computer, a laptop computer, a wearable computer, and the like are exemplified. The management system 200 may also store the information by using a distributed ledger technology or a distributed network such as a block chain.

In a case where at least a part of components constituting the management system 200 is realized by software, the component realized by the software may be realized by activating a program that regulates the operation related to the component in an information processing device having a general configuration. The above-described information processing device may include (i) a data processing device having processors such as a CPU or a GPU, a ROM, a RAM, a communication interface, and the like, (ii) input devices such as a keyboard, a touch panel, a camera, a microphone, various types of sensors, and a GPS receiver, (iii) output devices such as a display device, a speaker, and a vibration device, and (iv) storage devices (including external storage devices) such as a memory and a HDD. In the above-described information processing device, the above-described data processing device or storage device may store the above-described program. The above-described program causes the information processing device described above to perform the operations regulated by this program, by being executed by the processor. The above-described program may also be stored in a non-transitory computer-readable recording medium.

The above-described program may also be a program that causes a computer to execute one or a plurality of procedures related to various types of information processing in the management system 200. The above-described program may be a program that causes a computer to function as a control apparatus that controls the lawn mower 210.

One or a plurality of procedures related to various types of information processing in the management system 200 may also be procedures for controlling the lawn mower 210. The procedures for controlling the lawn mower 210 have, for example, the vibration information obtaining process for obtaining the vibration information related to the vibration detected by the vibration detection section from the vibration detection section mounted to the lawn mower 210. The above-described control method has, for example, a control step for controlling at least one of the progress direction, the progress speed, the travel mode, and the work mode of the lawn mower 210 on the basis of the vibration information obtained in the vibration information obtaining step. The above-described control method has, for example, a boundary detection step for detecting the boundary 206 on the basis of the vibration information obtained in the vibration information obtaining step. The above-described computer may be a computer mounted to at least one of the user terminal 22, the lawn mower 210, and the management server 230.

[Outline of Lawn Mower 210]

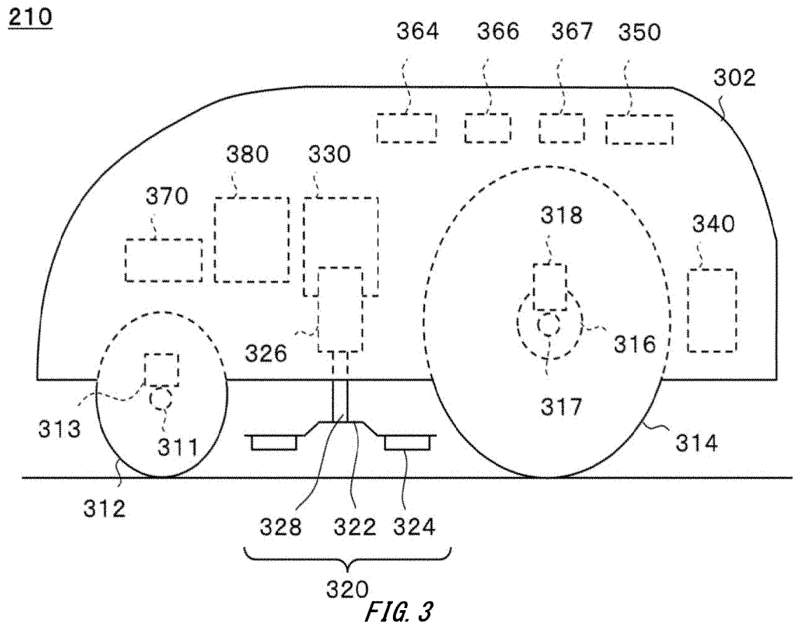

An outline of the lawn mower 210 will be described with reference to FIG. 3 to FIG. 9. FIG. 3 schematically illustrates one example of an internal configuration of the lawn mower 210. According to the present embodiment, the lawn mower 210 includes an enclosure 302. According to the present embodiment, the lawn mower 210 includes a pair of front wheels 312 and a pair of rear wheels 314 under the enclosure 302. The lawn mower 210 may include a pair of travel motors 316 that respectively drive a pair of rear wheels 314.

According to the present embodiment, the front wheels 312 are connected to an axle 311. The axle 311 is connected to the enclosure 302 via a suspension apparatus 313. According to the present embodiment, the rear wheels 314 are connected to an axle 317. The axle 317 is connected to the enclosure 302 via a suspension apparatus 318. According to the present embodiment, the suspension apparatus 318 may also be a suspension apparatus of a rigid axle suspension system (which may also be referred to as a rigid axle in some cases.), or may also be a suspension apparatus of an independent suspension system.

According to the present embodiment, the lawn mower 210 includes a work unit 320. The work unit 320 has, for example, a blade disk 322, a cutter blade 324, a work motor 326, and a shaft 328. The lawn mower 210 may also include a location adjustment section 330 that adjusts a location of the work unit 320.

The blade disk 322 is coupled to the work motor 326 via the shaft 328. The cutter blade 324 may be a cutting blade that cuts lawn. The cutter blade 324 is attached to the blade disk 322, and rotates together with the blade disk 322. The work motor 326 rotates the blade disk 322. The blade disk 322 and the cutter blade 324 may be one example of a cutting member that cuts a work target.

According to the present embodiment, the lawn mower 210 includes a battery unit 340, a user interface 350, an image capturing unit 364, a vibration sensor 366, a vibration sensor 367, a sensor unit 370, and a control unit 380 inside the enclosure 302 or on the enclosure 302. The image capturing unit 364 may be one example of an image capturing section. The vibration sensor 366 and the vibration sensor 367 may be one example of the vibration detection section. The vibration sensor 366 may be one example of one of the first vibration detection section and the second vibration detection section. The vibration sensor 367 may be one example of the other example of the first vibration detection section and the second vibration detection section. The control unit 380 may be one example of the control apparatus.

The control unit 380 may have a configuration similar to the control apparatus 180 as long as a technical contradiction is not made. Similarly, the control apparatus 180 may have a configuration similar to the control unit 380 as long as a technical contradiction is not made.

According to the present embodiment, the battery unit 340 supplies power to each portion of the lawn mower 210. According to the present embodiment, the user interface 350 accepts an input of the user. The user interface 350 outputs information to the user. As the user interface 350, a keyboard, a pointing device, a microphone, a touch panel, a display, a speaker, and the like are exemplified.

According to the present embodiment, the image capturing unit 364 captures an image of a surrounding of the lawn mower 210. The image capturing unit 364 may capture an image of at least a part of the work region 202. The image capturing unit 364 may transmit data of the captured image to the management server 230. The image may also be a video image, or may also be a still image. The image may also be a wide angle image, may also be a 180-degree panoramic image, or may also be a 360-degree panoramic image. The image may also be an image captured by a visible light camera, or may also be an image captured by an infrared camera.

The image data may also be information in which the data of the captured image is associated with information indicating a location where the image is captured. The image data may also be information in which the data of the captured image is associated with information indicating a time when the image is captured. The information indicating the location where the image is captured may be one example of the information for associating the location where the vibration is detected with the location where the image is captured. The information indicating the time when the image is captured may be one example of the information for associating the location where the vibration is detected with the location where the image is captured.

In a case where at least one of the vibration sensor 366 and the vibration sensor 367 detects the vibration larger than a predetermined threshold, the image capturing unit 364 may transmit the image data of the image captured during a period including the time when the vibration is detected to the management server 230. For example, the image capturing unit 364 transmits the image data of the image captured in 30 seconds around the time when the vibration is detected to the management server 230.

A duration of the above-described period is not particularly limited, but the above-described period preferably includes a period from a time one minute before the time when the vibration is detected to the time when the vibration is detected, more preferably includes a period from a time 30 seconds before the time when the vibration is detected to the time when the vibration is detected, and further preferably includes a period from a time 15 seconds before the time when the vibration is detected to the time when the vibration is detected. The above-described period preferably includes a period from the time when the vibration is detected to a time one minute after the time when the vibration is detected, more preferably includes a period from the time when the vibration is detected to a time 30 seconds after the time when the vibration is detected, and further preferably includes a period from the time when the vibration is detected to a time 15 seconds after the time when the vibration is detected.

The image capturing unit 364 may also transmit information indicating at least one of an image capturing direction and an image capturing condition to the management server 230. As the image capturing condition, a zoom magnification, an aperture, whether an optical filter is present or is needed, a type of an optical filter, a resolution, a shatter speed, a frame rate, an ISO sensitivity, a capturing altitude, an angle of view, a focal length, a render setting, and the like are exemplified. The image capturing unit 364 may also execute various types of processing on the basis of a control signal from the control unit 380. As the above-described processing, start of image capturing, stop of image capturing, adjustment or change of the image capturing direction, adjustment or change of the image capturing condition, saving of the image data, transmission of the image data, and the like are exemplified.

The vibration sensor 366 and the vibration sensor 367 detect vibration of the lawn mower 210. The vibration sensor 366 and the vibration sensor 367 output information related to the detected vibration (which may be referred to as vibration data in some cases). For example, the vibration sensor 366 and the vibration sensor 367 transmit the vibration data to the management server 230. As described above, the vibration data may be the data in which the information indicating the time is associated with the information indicating the magnitude of the vibration at the time.

The vibration sensor 366 and the vibration sensor 367 may have a configuration similar to the vibration detection section 160 as long as a technical contradiction is not made. Similarly, the vibration detection section 160 may have a configuration similar to at least one of the vibration sensor 366 and the vibration sensor 367 as long as a technical contradiction is not made.

The vibration sensor 366 and the vibration sensor 367 may be disposed in locations suitable to detect the vibration corresponding to the main detection target of the sensors. At least one of the vibration sensor 366 and the vibration sensor 367 may mainly detect the vibration of the enclosure 302. At least one of the vibration sensor 366 and the vibration sensor 367 may also mainly detect the vibration of the front wheels 312 or the rear wheels 314. For example, the vibration sensor 366 mainly detects the vibration of the front wheel 312 on the right side, and the vibration sensor 367 mainly detects the vibration of the front wheel 312 on the left side. The vibration sensor 366 may also mainly detect the vibration of the rear wheels 314 on the right side, and the vibration sensor 367 may also mainly detect the vibration of the rear wheels 314 on the left side.

For example, at least one of the vibration sensor 366 and the vibration sensor 367 is disposed in at least one of (i) the enclosure 302, (ii) the front wheels 312 or the rear wheels 314, (iii) the axle 311 or the axle 317, and (iv) the suspension apparatus 313 or the suspension apparatus 318. At least one of the vibration sensor 366 and the vibration sensor 367 may be disposed in at least one of (i) the front wheels 312 or the rear wheels 314, and (ii) the axle 311 or the axle 317. Thus, at least one of the vibration sensor 366 and the vibration sensor 367 can more precisely obtain the vibration generated by the contact of the front wheels 312 or the rear wheels 314 with the ground.

It is noted that the vibration sensor 366 and the vibration sensor 367 are one example of a plurality of vibration sensors, and an arrangement method of the plurality of vibration sensors is not limited to the present embodiment.

According to one embodiment, at least one vibration sensor may also be disposed on a right side relative to the center of gravity of the enclosure 302, and at least one vibration sensor may also be disposed on a left side relative to the center of gravity of the enclosure 302. At least one vibration sensor may also be disposed in the vicinity of the center of gravity of the enclosure 302, at least one vibration sensor may also be disposed on the right side relative to the center of gravity of the enclosure 302, and at least one vibration sensor may also be disposed on the left side relative to the center of gravity of the enclosure 302.

According to another embodiment, at least one vibration sensor may also be disposed on a front side relative to the center of gravity of the enclosure 302, and at least one vibration sensor may also be disposed on a rear side relative to the center of gravity of the enclosure 302. At least one vibration sensor may also be disposed in the vicinity of the center of gravity of the enclosure 302, at least one vibration sensor may also be disposed on the front side relative to the center of gravity of the enclosure 302, and at least one vibration sensor may also be disposed on the rear side relative to the center of gravity of the enclosure 302.

According to still another embodiment, at least one vibration sensor may also be disposed on an upper side relative to the center of gravity of the enclosure 302, and at least one vibration sensor may also be disposed on a lower side relative to the center of gravity of the enclosure 302. At least one vibration sensor may also be disposed in the vicinity of the center of gravity of the enclosure 302, at least one vibration sensor may also be disposed on the upper side relative to the center of gravity of the enclosure 302, and at least one vibration sensor may also be disposed on the lower side relative to the center of gravity of the enclosure 302.

Installment locations of a plurality of vibration sensors may also be decided by a combination of the above-described three arrangement methods. In addition, as described above, a member in which the vibration sensor is disposed is not particularly limited. For example, the vibration sensor may be disposed in the enclosure 302, the front wheels 312, the rear wheels 314, the axle 311, the axle 317, the suspension apparatus 313, the suspension apparatus 318, or the like.

According to the present embodiment, the sensor unit 370 includes various sensors. The sensor unit 370 may include various internal sensors. The sensor unit 370 may include various external sensors. The sensor unit 370 may transmit outputs of various sensors to the control unit 380. As the sensor, a millimeter wave sensor, a proximity detection sensor, a wheel speed sensor, a load sensor, an idling detection sensor, a magnetic sensor, a geomagnetic sensor (which may also be referred to as an orientation sensor, electronic compass, or the like in some cases), a soil moisture sensor, and the like are exemplified. The wheel speed sensor may also be a rotary encoder that detects a rotation angle or the rotation number of the wheel. The sensor unit 370 may also include a sensor that detects a locational fluctuation of the axle 311 or the axle 317, a sensor that detects an acceleration rate of the lawn mower 210 in the vicinity of the center of gravity, a sensor that detects an angular velocity of the lawn mower 210 in the vicinity of the center of gravity, or the like.

According to the present embodiment, the control unit 380 controls the operation of the lawn mower 210. According to one embodiment, the control unit 380 controls the one pair of travel motors 316 to control the movement of the lawn mower 210. According to another embodiment, the control unit 380 controls the work motor 326 to control the work of the lawn mower 210.

The control unit 380 may control the operation of the lawn mower 210 on the basis of an output from at least one of the image capturing unit 364, the vibration sensor 366, the vibration sensor 367, and the sensor unit 370. The control unit 380 may also control the operation of the lawn mower 210 on the basis of an instruction from the management server 230. The lawn mower 210 may be controlled on the basis of the information of the work schedule generated by the management server 230. The control unit 380 may also control the lawn mower 210 in accordance with the command generated by the management server 230. A detail of the control unit 380 will be described below.

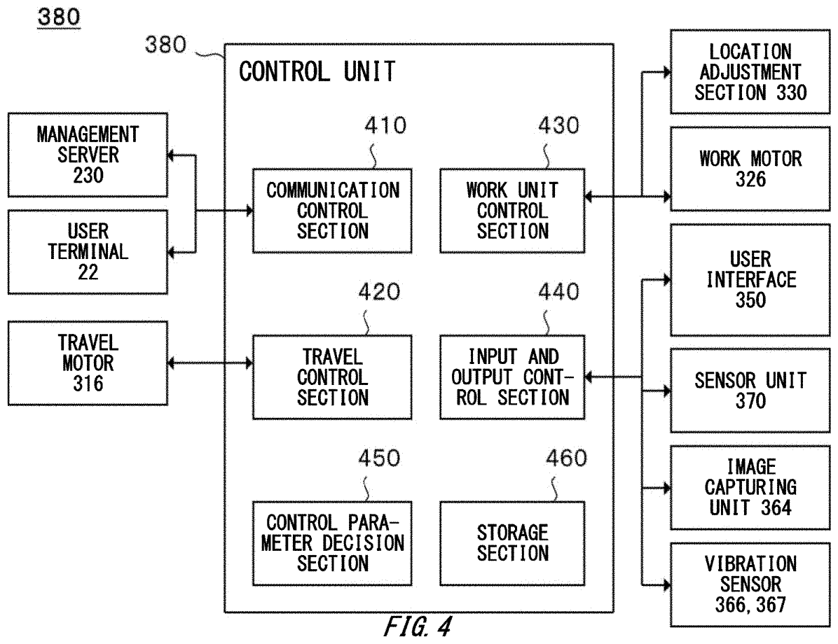

FIG. 4 schematically illustrates one example of an internal configuration of the control unit 380. According to the present embodiment, the control unit 380 includes a communication control section 410, a travel control section 420, a work unit control section 430, and an input and output control section 440.

According to the present embodiment, the control unit 380 includes a control parameter decision section 450. The control unit 380 may also include a storage section 460. The control parameter decision section 450 may be one example of the control apparatus. As long as a technical contradiction is not made, the control parameter decision section 450 may also have a configuration similar to the control apparatus 180 described in association with FIG. 1. Similarly, as long as a technical contradiction is not made, the control apparatus 180 may have a configuration similar to the control parameter decision section 450.

According to the present embodiment, the communication control section 410 controls a communication with an external apparatus of the lawn mower 210. The communication control section 410 may also be a communication interface compatible with one or a plurality of communication methods. As the external apparatus, the user terminal 22, the management server 230, and the like are exemplified.

According to the present embodiment, the travel control section 420 controls the travel motor 316 to control the movement of the lawn mower 210. The travel control section 420 controls autonomous travel of the lawn mower 210. For example, the travel control section 420 controls at least one of the progress speed, the progress direction, the travel mode, and a travel route of the lawn mower 210. The travel control section 420 may execute at least one of straight-ahead progress control, rotation control, and circulation control of the lawn mower 210 using the data output by the sensor unit 370. The travel control section 420 may also monitor a current value of the travel motor 316.

According to the present embodiment, the work unit control section 430 controls the work unit 320. The work unit control section 430 may control at least one of the work mode of the work unit 320, the type of the work, the intensity of the work, and the timing when the work is to be performed. For example, the work unit control section 430 controls the work motor 326 to control the intensity of the work of the work unit 320. The work unit control section 430 may also control the location adjustment section 330 to control the intensity of the work of the work unit 320. The work unit control section 430 may monitor a current value of the work motor 326.

According to the present embodiment, the input and output control section 440 accepts an input from at least one of the user interface 350, the image capturing unit 364, the vibration sensor 366, the vibration sensor 367, and the sensor unit 370. The input and output control section 440 may also control at least one of the user interface 350, the image capturing unit 364, the vibration sensor 366, the vibration sensor 367, and the sensor unit 370.

The input and output control section 440 outputs the information to the user interface 350. The input and output control section 440 may also output the information to at least one of the user terminal 22 and the management server 230 via the communication control section 410. For example, in a case where the estimation precision of the self-location of the lawn mower 210 does not satisfy a predetermined reference or a case where any defect occurs in the lawn mower 210, the input and output control section 440 outputs the information indicating the state of the lawn mower 210 to at least one of the user terminal 22 and the management server 230.

According to the present embodiment, the control parameter decision section 450 decides a parameter for controlling at least one of the travel control section 420 and the work unit control section 430 (which may be referred to as a control parameter in some cases). The control parameter decision section 450 controls at least one of the progress direction, the progress speed, the travel mode, and the work mode of the lawn mower 210 on the basis of the vibration data output by at least one of the vibration sensor 366 and the vibration sensor 367.

For example, the control parameter decision section 450 (i) receives the vibration data output by at least one of the vibration sensor 366 and the vibration sensor 367, and (ii) outputs the control parameter. The control parameter decision section 450 may generate the control parameter for controlling at least one of the progress direction, the progress speed, the work mode, and the travel mode of the lawn mower 210 on the basis of the input vibration data.

The control parameter decision section 450 may also decide whether to change the control parameter. For example, the control parameter decision section 450 (i) receives the vibration data output by at least one of the vibration sensor 366 and the vibration sensor 367, and (ii) outputs the information indicating whether to change the control parameter. A detail of the control parameter decision section 450 will be described below.

According to the present embodiment, the storage section 460 stores various information. The storage section 460 may store various information to be used for the control parameter decision section 450 to generate the control parameter.

According to one embodiment, the storage section 460 may store geographical information related to the work region 202. According to another embodiment, the storage section 460 may store setting information for deciding the operation of the lawn mower 210. As the setting information, setting information related to the operation of the lawn mower 210 in a case where a change of the vibration pattern is detected, setting information related to the operation of the lawn mower 210 in a case where a particular vibration pattern is detected, and the like are exemplified. The above-described setting information may be one example of the control information.

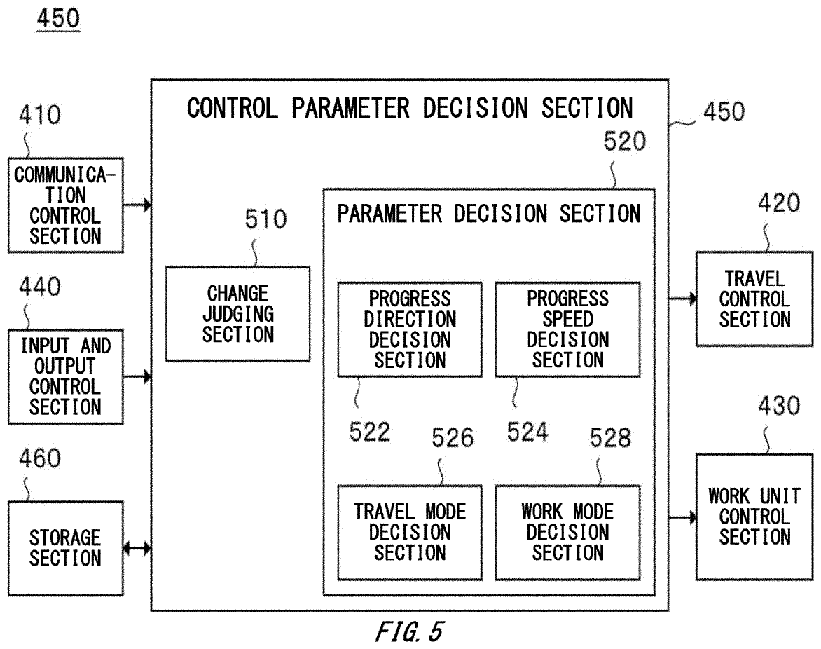

FIG. 5 schematically illustrates one example of an internal configuration of the control parameter decision section 450. According to the present embodiment, the control parameter decision section 450 includes a change judging section 510 and a parameter decision section 520. According to the present embodiment, the parameter decision section 520 has a progress direction decision section 522, a progress speed decision section 524, a travel mode decision section 526, and a work mode decision section 528.

The change judging section 510 may be one example of the control apparatus, the vibration information obtaining section, the control section, and a change decision section. The parameter decision section 520 may be one example of the control section. The progress direction decision section 522 may be one example of a command output section.

According to the present embodiment, the change judging section 510 judges whether the change of the control parameter is needed on the basis of the vibration data output by at least one of the vibration sensor 366 and the vibration sensor 367. The change judging section 510 may also decide a control parameter that is to be changed among a plurality of types of control parameters. Thus, the change judging section 510 can control at least one of the progress direction, the progress speed, the work mode, and the travel mode of the lawn mower 210 on the basis of the vibration data output by at least one of the vibration sensor 366 and the vibration sensor 367.

According to one embodiment, the change judging section 510 may also judge whether the change of the control parameter is needed, and the like on the basis of the vibration data output by at least one of the vibration sensor 366 and the vibration sensor 367. According to another embodiment, in a case where the boundary 206 of the work region 202 is detected, the change judging section 510 may also judge whether the change of the control parameter is needed, and the like. In a case where the boundary 206 of the work region 202 is detected on the basis of the vibration data, the change judging section 510 may also judge whether the change of the control parameter is needed, and the like.

As the boundary 206 of the work region 202, (i) a boundary for distinguishing the inside and the outside of the work region 202, (ii) a boundary for distinguishing an outer edge of an obstacle or the like disposed inside the work region 202, and the like are exemplified. A detail of the change judging section 510 will be described below.

According to the present embodiment, the parameter decision section 520 decides contents of the various control parameters. For example, in a case where the change judging section 510 judges that the change of the control parameter is needed, the parameter decision section 520 decides the contents of the control parameter. The parameter decision section 520 may decide the contents of the control parameter which has been decided by the change judging section 510 as the control parameter to be change among the plurality of types of control parameters.

According to the present embodiment, the progress direction decision section 522 decides the control parameter for controlling the progress direction of the lawn mower 210. For example, the progress direction decision section 522 decides the above-described control parameter in a case where the change judging section 510 judges that the progress direction of the lawn mower 210 is to be changed. The progress direction decision section 522 may output the control parameter indicating the progress direction after the change. The control parameter output by the progress direction decision section 522 is transmitted to the travel control section 420, for example. Thus, the progress direction decision section 522 can control the progress direction of the lawn mower 210. The above-described control parameter may be one example of a command for changing the progress direction of the lawn mower 210.

More specifically, the progress direction decision section 522 may decide an angle defined by the progress direction before the change and the progress direction after the change using a probability model. In a case where a starting point of a plane vector indicating the progress direction before the change is overlapped with a starting point of a plane vector indicating the progress direction after the change, the “angle defined by the progress direction before the change and the progress direction after the change” may mean an angle corresponding to 180 degrees or less out of two angles formed by the above-described two vectors.

It is noted that according to the present embodiment, a detail of the progress direction decision section 522 will be described while a case is used as an example where the progress direction after the change is decided when the angle defined by the progress direction before the change and the progress direction after the change is decided. However, the method for the progress direction decision section 522 to decide the progress direction after the change is not limited to the present embodiment. According to another embodiment, the progress direction decision section 522 (i) may also decide the progress direction after the change by deciding a rotation amount of the lawn mower 210 in a turning location (for example, a rotation angle), or (ii) may also decide the progress direction after the change by deciding an orientation or a bearing indicating the progress direction after the change.

According to one embodiment, the progress direction decision section 522 randomly decides the progress direction after the change. Thus, in a case where the change judging section 510 judges that the progress direction of the lawn mower 210 is to be changed, the progress direction of the lawn mower 210 is randomly changed. As a result, a frequency at which the lawn mower 210 enters a particular region is adjusted.

According to another embodiment, the progress direction decision section 522 may decide the progress direction after the change such that the angle defined by the progress direction before the change and the progress direction after the change is within a particular numeric value range. The progress direction after the change may be calculated using any probability model.

For example, the progress direction decision section 522 sets the above-described numeric value range such that the angle defined by the progress direction before the change and the progress direction after the change is 90 degrees or more, preferably above 90 degrees, more preferably 120 degrees or more, and further preferably above 120 degrees. Then, the progress direction decision section 522 decides the progress direction after the change within the above-described numeric value range. Thus, the entry of the lawn mower 210 to the forward region in the progress direction is suppressed.

The progress direction decision section 522 may also set the above-described numeric value range such that the angle defined by the progress direction before the change and the progress direction after the change is 90 degrees or less, preferably below 90 degrees, more preferably 60 degrees or less, and further preferably below 60 degrees. Then, the progress direction decision section 522 decides the progress direction after the change within the above-described numeric value range. Thus, the entry of the lawn mower 210 to the forward region in the progress direction is promoted.

According to another embodiment, the progress direction decision section 522 may also decide the progress direction after the change on the basis of the type of the boundary 206. According to still another embodiment, the progress direction decision section 522 may decide the progress direction after the change on the basis of the estimated location of the lawn mower 210.

The progress direction after the change is indicated, for example, by the angle defined by the progress direction before the change and the progress direction after the change. The progress direction after the change may also be indicated by an angle defined by an extending direction of the adjacent boundary 206 and the progress direction after the change. The progress direction after the change may also be indicated by the orientation or the bearing. The progress direction after the change may also be indicated by identification information of a landmark set as a target. The progress direction after the change may also be indicated by an angle defined by using a particular landmark as a reference.

According to the present embodiment, the progress speed decision section 524 decides the control parameter for controlling the progress speed of the lawn mower 210. For example, the progress speed decision section 524 decides the above-described control parameter in a case where the change judging section 510 judges that the progress speed of the lawn mower 210 is to be changed. The progress speed decision section 524 may output the control parameter indicating the progress speed after the change. The control parameter output by the progress speed decision section 524 is transmitted to the travel control section 420, for example. Thus, the progress speed decision section 524 can control the progress speed of the lawn mower 210.

According to one embodiment, the progress speed decision section 524 may also decide the progress speed after the change on the basis of the type of the boundary 206. According to another embodiment, the progress speed decision section 524 may decide the progress speed after the change on the basis of the estimated location of the lawn mower 210. According to still another embodiment, the progress speed decision section 524 may decide the progress speed after the change on the basis of a time or a time slot.

According to the present embodiment, the travel mode decision section 526 decides the control parameter for controlling the travel mode of the lawn mower 210. For example, in a case where the change judging section 510 judges that the travel mode of the lawn mower 210 is to be changed, the travel mode decision section 526 decides the above-described control parameter. The travel mode decision section 526 may output the control parameter indicating the travel mode after the change. The control parameter output by the travel mode decision section 526 is transmitted to the travel control section 420, for example. Thus, the travel mode decision section 526 can control the travel mode of the lawn mower 210.

According to one embodiment, the travel mode decision section 526 may also decide the travel mode after the change on the basis of the type of the boundary 206. According to another embodiment, the travel mode decision section 526 may decide the travel mode after the change on the basis of the estimated location of the lawn mower 210. According to still another embodiment, the travel mode decision section 526 may decide the travel mode after the change on the basis of a time or a time slot.

According to the present embodiment, the work mode decision section 528 decides the control parameter for controlling the work mode of the lawn mower 210. For example, in a case where the change judging section 510 judges that the work mode of the lawn mower 210 is to be changed, the work mode decision section 528 decides the above-described control parameter. The work mode decision section 528 may output the control parameter indicating the work mode after the change. The control parameter output by the work mode decision section 528 is transmitted to the work unit control section 430, for example. Thus, the work mode decision section 528 can control the work mode of the lawn mower 210.

According to one embodiment, the work mode decision section 528 may also decide the work mode after the change on the basis of the type of the boundary 206. According to another embodiment, the work mode decision section 528 may decide the work mode after the change on the basis of the estimated location of the lawn mower 210. According to still another embodiment, the work mode decision section 528 may decide the work mode after the change on the basis of a time or a time slot.

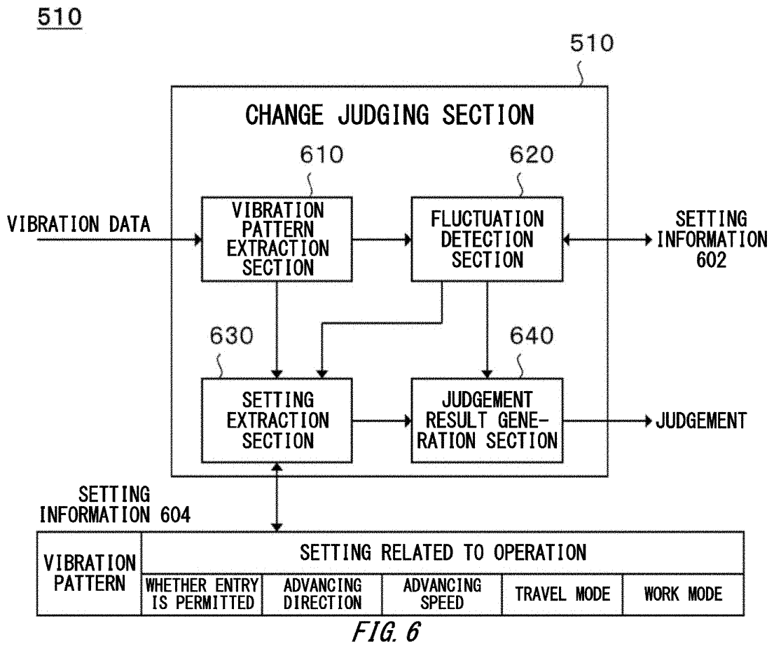

FIG. 6 schematically illustrates one example of an internal configuration of the change judging section 510. According to the present embodiment, the change judging section 510 includes a vibration pattern extraction section 610, a fluctuation detection section 620, a setting extraction section 630, and a judgement result generation section 640. The vibration pattern extraction section 610 may be one example of the vibration information obtaining section. The fluctuation detection section 620 may be one example of the control section and the boundary detection section. The setting extraction section 630 may be one example of the extraction section. The judgement result generation section 640 may be one example of the control section, the command output section, and the change decision section.

According to the present embodiment, the vibration pattern extraction section 610 obtains the vibration data output by at least one of the vibration sensor 366 and the vibration sensor 367. The vibration pattern extraction section 610 analyzes each of one or a plurality of the vibration data, and extracts one or a plurality of the vibration patterns included in each vibration data. The vibration pattern extraction section 610 transmits the information indicating the extracted vibration pattern to the fluctuation detection section 620. The vibration pattern extraction section 610 may also transmit the information indicating the extracted vibration pattern to the setting extraction section 630.

For example, the vibration pattern extraction section 610 analyzes the vibration data of the last 10 seconds every 0.1 seconds, and extracts one or a plurality of the vibration patterns included in the vibration data. The timing when the vibration pattern extraction section 610 analyzes each vibration data is not particularly limited. For example, the vibration pattern extraction section 610 analyzes the vibration data at a predetermined time interval, and extracts one or a plurality of the vibration patterns included in the vibration data. The timing when the vibration pattern extraction section 610 analyzes each vibration data may also be decided according to the progress speed of the lawn mower 210.

Similarly, a length of the vibration data used in the analysis in each time is not particularly limited. For example, the vibration pattern extraction section 610 buffers the vibration data transmitted from the vibration sensor 366 and the vibration sensor 367 from moment to moment, and extracts the vibration data obtained from a first time to a second time. The second time may be a time later than the first time. The vibration pattern extraction section 610 analyzes the extracted vibration data, and extracts one or a plurality of the vibration patterns included in the vibration data.

The vibration pattern extraction section 610 may also decide one or a plurality of the vibration patterns included in the vibration data by comparing a feature of the vibration pattern included in the vibration data with a feature of a predetermined the vibration pattern. The vibration pattern extraction section 610 may also decide one or a plurality of the vibration patterns included in the vibration data by judging whether the vibration data has the feature of the particular vibration pattern.

According to one embodiment, the vibration pattern extraction section 610 inputs the vibration data output by each of the vibration sensor 366 and the vibration sensor 367 to the learning machine that has already performed the learning. The vibration pattern extraction section 610 outputs each of the identification information of one or a plurality of the vibration pattern output from the learning machine.

According to another embodiment, the vibration pattern extraction section 610 analyzes the vibration data output by each of the vibration sensor 366 and the vibration sensor 367, and calculates the frequency distribution of the vibration waveform. The vibration pattern extraction section 610 decides one or a plurality of the vibration patterns included in the vibration data on the basis of the distribution shape of the frequency distribution. The vibration pattern extraction section 610 outputs each of the identification information of one or a plurality of the vibration pattern determined as being included in the vibration data.

According to another embodiment, the vibration pattern extraction section 610 analyzes the vibration data output by each of the vibration sensor 366 and the vibration sensor 367, and calculates an appearing pattern of the vibration at the particular frequency. The vibration pattern extraction section 610 decides one or a plurality of the vibration patterns included in the vibration data on the basis of the appearing pattern of the vibration at the particular frequency. The vibration pattern extraction section 610 outputs each of the identification information of one or a plurality of the vibration pattern determined as being included in the vibration data.

According to still another embodiment, the vibration pattern extraction section 610 analyzes the vibration data output by each of the vibration sensor 366 and the vibration sensor 367, and calculates a statistic of the magnitude of the vibration. One or a plurality of the vibration patterns included in the vibration data are decided on the basis of the statistic of the magnitude of the vibration. The vibration pattern extraction section 610 outputs each of the identification information of one or a plurality of the vibration pattern determined as being included in the vibration data.

According to still another embodiment, the vibration pattern extraction section 610 analyzes the vibration data output by each of the vibration sensor 366 and the vibration sensor 367, and calculates an intermittent pattern of the vibration. The vibration pattern extraction section 610 decides one or a plurality of the vibration patterns included in the vibration data on the basis of the intermittent pattern of the vibration. The vibration pattern extraction section 610 outputs each of the identification information of one or a plurality of the vibration pattern determined as being included in the vibration data.

The vibration pattern extraction section 610 may analyze each of one or a plurality of the vibration data, eliminate the noise included in each vibration data, and extract the data of the vibration on which the type or the feature of the ground has been reflected. The vibration pattern extraction section 610 may also analyze the data of the vibration on which the type or the feature of the ground has been reflected to extract one or a plurality of the vibration pattern.

The vibration pattern extraction section 610 may eliminate the noise generated by the travel motor 316 on the basis of (i) the information indicating the current value of the current supplied to the travel motor 316, or (ii) the information indicating whether the travel motor 316 is actuated. The vibration pattern extraction section 610 may eliminate the noise generated by the work motor 326 on the basis of (i) the information indicating the current value of the current supplied to the work motor 326, or (ii) the information indicating whether the work motor 326 is actuated.

The vibration pattern extraction section 610 may also eliminate the noise included in each vibration data using the data output by the sensor unit 370. The vibration pattern extraction section 610 may also connect each vibration data using the data output by the sensor unit 370. For example, in a case where a moisture detection sensor included in the sensor unit 370 detects that a moisture content of the ground is higher than a predetermined value, the vibration pattern extraction section 610 corrects the vibration data such that the amplitude of the detected vibration is increased.

According to the present embodiment, the fluctuation detection section 620 obtains information indicating one or a plurality of the vibration pattern extracted from each of one or a plurality of the vibration data. The fluctuation detection section 620 judges whether the vibration pattern is changed with regard to each of one or a plurality of the vibration data. In a case where it is judged that the vibration pattern is changed, for example, the fluctuation detection section 620 outputs the information indicating that the vibration pattern is changed to the setting extraction section 630.

[One Example of Information Processing in Case where Vibration Pattern is Changed]

According to one embodiment, in a case where it is judged that the vibration pattern is changed, the fluctuation detection section 620 decides whether to change at least one of the progress direction, the progress speed, the work mode, and the travel mode of the lawn mower 210. The fluctuation detection section 620 may also judge whether to continue the progress of the lawn mower 210 on the basis of the change of the vibration pattern.

The fluctuation detection section 620 may refer to setting information 602 stored in the storage section 460, for example, and decide whether to change at least one of the progress direction, the progress speed, the work mode, and the travel mode of the lawn mower 210. The fluctuation detection section 620 may also refer to the setting information 602, and decide contents of the change of at least one of the progress direction, the progress speed, the work mode, and the travel mode of the lawn mower 210.

The setting information 602 may be information indicating the setting related to the operation of the lawn mower 210 in a case where the change of the vibration pattern is detected. As the setting related to the operation of the lawn mower 210, (i) immediate stop of the progress of the lawn mower 210, (ii) after immediate stop of the progress of the lawn mower 210, turning of the lawn mower 210 in a direction opposite to the progress direction or reversing of the lawn mower 210, (iii) continuing of the progress by reducing the progress speed of the lawn mower 210, (iv) continuing of the progress without changing the progress speed of the lawn mower 210, and the like are exemplified.

For example, in a case where the vibration pattern characteristic to the work region 202 is included in one or a plurality of the vibration patterns extracted by the vibration pattern extraction section 610, when the vibration pattern characteristic to the work region 202 is no longer included over time, the fluctuation detection section 620 decides whether to change at least one of the progress direction, the progress speed, the work mode, and the travel mode of the lawn mower 210. In this case, the fluctuation detection section 620 may decide that the progress of the lawn mower 210 is not continued. Specifically, the fluctuation detection section 620 decides that the progress direction of the lawn mower 210 is to be changed. The fluctuation detection section 620 may also decide that the progress of the lawn mower 210 is immediately stopped to make a turn.

In a case where the vibration pattern characteristic to the work region 202 is included in one or a plurality of the vibration patterns extracted by the vibration pattern extraction section 610, when the vibration pattern characteristic to the work region 202 is changed to the vibration pattern characteristic to the non-work region different from the work region 202 over time, the fluctuation detection section 620 may decide whether to change at least one of the progress direction, the progress speed, the work mode, and the travel mode of the lawn mower 210. In this case, the fluctuation detection section 620 may decide that the progress of the lawn mower 210 is not continued.

On the other hand, in a case where the vibration pattern characteristic to the non-work region different from the work region 202 is included, and the vibration pattern characteristic to the work region 202 is not included in one or a plurality of the vibration patterns extracted by the vibration pattern extraction section 610, when the vibration pattern characteristic to the non-work region is changed to the vibration pattern characteristic to the work region 202 over time, the fluctuation detection section 620 may decide whether to change at least one of the progress direction, the progress speed, the work mode, and the travel mode of the lawn mower 210. It is to be understood that a case where it is judged that the vibration pattern is changed is not limited to the above-described case.

In a case where it is decided that at least one of the progress direction, the progress speed, the work mode, and the travel mode of the lawn mower 210 is to be changed, the fluctuation detection section 620 outputs information indicating the decision result to the judgement result generation section 640. Thus, the fluctuation detection section 620 can control at least one of the progress direction, the progress speed, the travel mode, and the work mode of the lawn mower 210 on the basis of the vibration data output by at least one of the vibration sensor 366 and the vibration sensor 367.

[Another Example of Information Processing in Case where Vibration Pattern is Changed]

According to another embodiment, in a case where it is judged that the vibration pattern is changed, the fluctuation detection section 620 decides whether the lawn mower 210 exists on the boundary 206 of the work region 202. Thus, the fluctuation detection section 620 can detect the boundary 206 of the work region 202. The above-described boundary 206 may also be a boundary that separates the inside of the work region 202 of the lawn mower 210 and the outside (for example, the non-work region), of may also be a boundary existing inside the work region 202.

For example, in a case where the vibration pattern characteristic to the work region 202 is included in one or a plurality of the vibration patterns extracted by the vibration pattern extraction section 610, the vibration pattern characteristic to the work region 202 is no longer included over time, the fluctuation detection section 620 detects the boundary 206. In a case where the vibration pattern characteristic to the work region 202 is included in one or a plurality of the vibration patterns extracted by the vibration pattern extraction section 610, when the vibration pattern characteristic to the work region 202 is changed to the vibration pattern characteristic to the non-work region different from the work region 202 over time, the fluctuation detection section 620 may detect the boundary 206. In a case where the vibration pattern characteristic to the non-work region different from the work region 202 is included, and the vibration pattern characteristic to the work region 202 is not included in one or a plurality of the vibration patterns extracted by the vibration pattern extraction section 610, when the vibration pattern characteristic to the non-work region is changed to the vibration pattern characteristic to the work region 202 over time, the fluctuation detection section 620 may detect the boundary 206.

The fluctuation detection section 620 may also decide the type of the boundary 206 in contact with the lawn mower 210 on the basis of the vibration pattern extracted by the vibration pattern extraction section 610. Specifically, the fluctuation detection section 620 may also decide the type of the boundary 206 in contact with the lawn mower 210 by referring to the information in which (i) the type of the vibration pattern or the combination of the plurality of vibration patterns is associated with (ii) the type of the boundary.

The fluctuation detection section 620 may also estimate an entry angle of the lawn mower 210 to the boundary 206. For example, the fluctuation detection section 620 estimates the entry angle of the lawn mower 210 to the boundary 206 on the basis of the vibration data output by the vibration sensor 366 and the vibration data output by the vibration sensor 367. Specifically, the fluctuation detection section 620 may estimate the entry angle of the lawn mower 210 to the boundary 206 on the basis of a time difference between a time when the change of the vibration pattern is detected in the vibration data output by the vibration sensor 366 and a time when the change of the vibration pattern is detected in the vibration data output by the vibration sensor 367.

The fluctuation detection section 620 may also estimate the entry angle of the lawn mower 210 to the boundary 206 on the basis of the vibration data output by the vibration sensor 366, the vibration data output by the vibration sensor 367, and the data output by the sensor unit 370. As the data output by the sensor unit 370, (i) data indicating whether straight-ahead progress maintaining control is actuated, (ii) data indicating a torque or a current value of the motor, (iii) data indicating a fluctuation of a load balance applied to each wheel, (iv) data indicating a relative locational relationship between each wheel or each axle and a reference location of the suspension apparatus (which may be referred to as a stroke in some cases), and the like are exemplified.

More specifically, the fluctuation detection section 620 estimates the entry angle of the lawn mower 210 to the boundary 206, for example, on the basis of the output of the vibration sensor that mainly detects the vibration of the wheels on the right side, the output of the vibration sensor that mainly detects the vibration of the wheels on the left side, and the output of the sensor that measures the progress speed of the lawn mower 210. The fluctuation detection section 620 may estimate the entry angle of the lawn mower 210 to the boundary 206 on the basis of the output of the vibration sensor that mainly detects the vibration of the wheels on the right side, the output of the vibration sensor that mainly detects the vibration of the wheels on the left side, the output of the sensor that measures the progress speed of the lawn mower 210, and the information indicating the width of the vehicle body. The information indicating the width of the vehicle body may be information indicating an interval of the left and right wheels. The wheel may also be front wheels, may also be rear wheels, and may also be a continuous track.

According to the present embodiment, the setting extraction section 630 decides the contents of the change related to the operation of the lawn mower 210. For example, the setting extraction section 630 decides the contents of the change related to at least one of the progress direction, the progress speed, the work mode, and the travel mode of the lawn mower 210.

According to the present embodiment, the setting extraction section 630 refers to setting information 604 stored in the storage section 460, for example, and decides the contents of the change related to the operation of the lawn mower 210. More specifically, the setting extraction section 630 refers to the setting information 604, and extracts the operation of the lawn mower 210 associated with the vibration pattern that is matched with at least one of one or a plurality of the vibration patterns extracted by the vibration pattern extraction section 610.

The setting information 604 may be information in which (i) each of the predetermined one or more of the vibration patterns is associated with (ii) the operation of the lawn mower 210. The setting information 604 may store (i) identification information of each of the predetermined one or more of the vibration patterns, and (ii) information indicating whether the entry is permitted to the region where the vibration pattern is detected while being associated with each other. The setting information 604 may also store (i) the identification information of each of the predetermined one or more of the vibration patterns, and (ii) information indicating the contents of the change related to at least one of the progress direction, the progress speed, the travel mode, and the work mode while being associated with each other.

A different operation may also be associated in accordance with the change of the vibration pattern in the setting information 604. For example, the setting information 604 stores (i) the identification information of each of the predetermined one or more of the vibration patterns, (ii) the identification information of the vibration pattern detected in the immediately preceding period, and (iii) the information indicating the contents of the change related to at least one of the progress direction, the progress speed, the travel mode, and the work mode while being associated with one another.

A combination of a plurality of vibration patterns may also be associated with an operation of the lawn mower 210 in the setting information 604. For example, the setting information 604 stores (i) the identification information of each of the predetermined one or more of the vibration patterns, (ii) the identification information of the vibration patterns detected at the same time, (iii) the information indicating the contents of the change related to at least one of the progress direction, the progress speed, the travel mode, and the work mode while being associated with one another.

The setting information 604 may also store the setting related to the operation of the lawn mower 210 in a case where the vibration pattern extracted by the vibration pattern extraction section 610 is unidentifiable. For example, the setting information 604 stores (i) the information indicating that the vibration pattern is unknown or unidentifiable, and (ii) the information indicating the contents of the change related to at least one of the progress direction, the progress speed, the travel mode, and the work mode while being associated with one another.

According to the present embodiment, the judgement result generation section 640 generates information indicating the judgement result related to whether the change of the control parameter is needed. The judgement result generation section 640 outputs the information indicating the judgement result to the parameter decision section 520. The information indicating the judgement result may be one example of the command for controlling or changing at least one of the progress direction, the progress speed, the work mode, and the travel mode of the lawn mower 210. Thus, the judgement result generation section 640 can control at least one of the progress direction, the progress speed, the work mode, and the travel mode of the lawn mower 210 on the basis of the vibration data output by at least one of the vibration sensor 366 and the vibration sensor 367.

More specifically, the judgement result generation section 640 obtains the information output by the fluctuation detection section 620. The judgement result generation section 640 obtains the information output by the setting extraction section 630. The judgement result generation section 640 decides that at least one of the progress direction, the progress speed, the work mode, and the travel mode of the lawn mower 210 is to be changed on the basis of the information output by at least one of the fluctuation detection section 620 and the setting extraction section 630.

In a case where the fluctuation detection section 620 decides that the progress of the lawn mower 210 is continued, the judgement result generation section 640 may decide that the progress direction is to be changed such that the lawn mower 210 progresses in substantially a perpendicular direction to the boundary 206. In a case where the fluctuation detection section 620 decide that the progress of the lawn mower 210 is not continued, the judgement result generation section 640 may decide that the progress direction is to be changed such that the lawn mower 210 progresses towards the inside of the work region 202. A specific direction of the progress direction is decided, for example, by the progress direction decision section 522.

According to the present embodiment, the case has been described where the control parameter decision section 450 is disposed in the lawn mower 210. However, the control parameter decision section 450 is not limited to the present embodiment. According to another embodiment, the control parameter decision section 450 or a part of the control parameter decision section 450 may also be disposed in the management server 230.

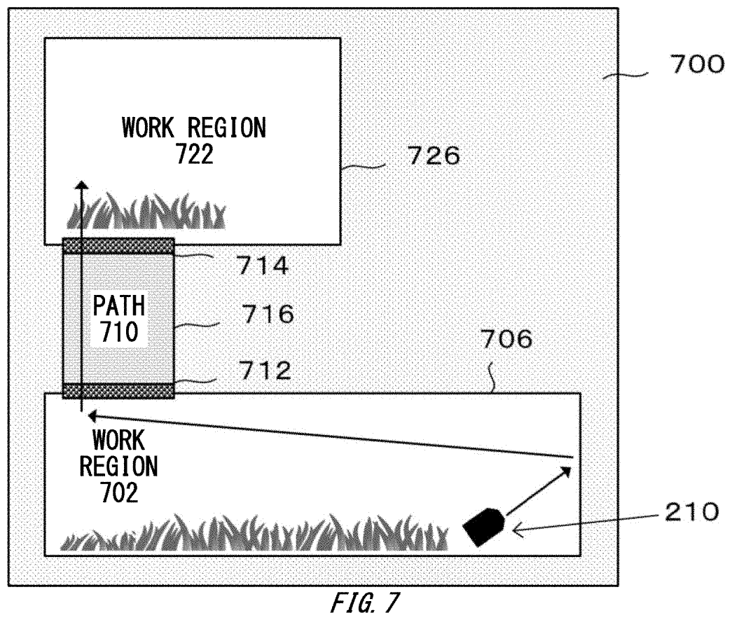

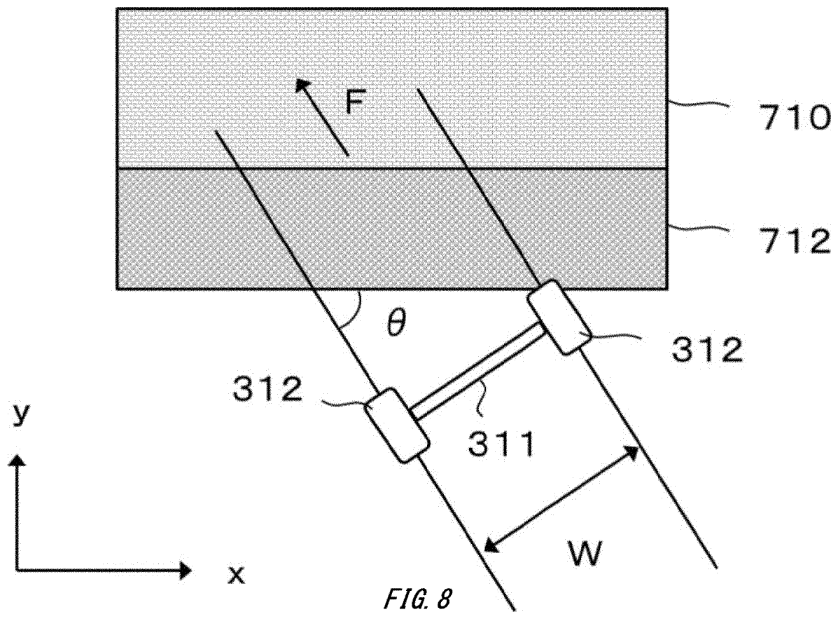

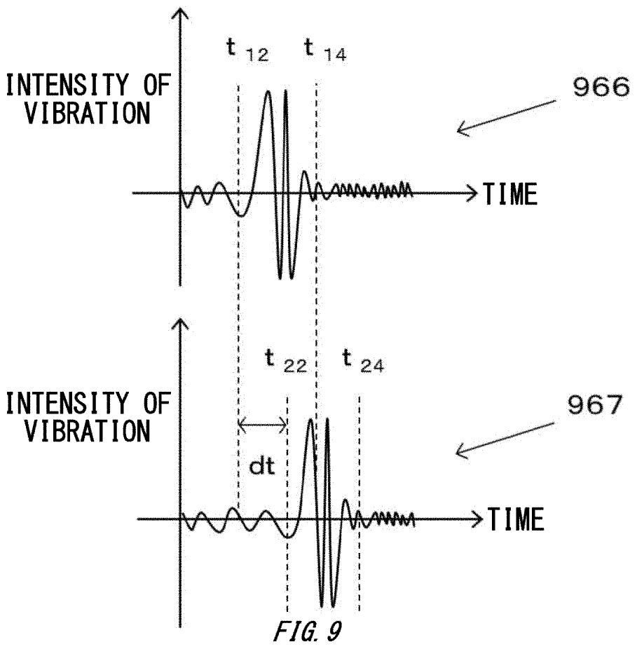

One example of information processing in the control unit 380 will be described with reference to FIG. 7, FIG. 8, and FIG. 9. FIG. 7 schematically illustrates one example of a method of controlling the operation of the lawn mower 210. FIG. 8 schematically illustrates one example of a situation when the lawn mower 210 enters a boundary represented by a tile 712. FIG. 9 schematically illustrates one example of the vibration data when the lawn mower 210 enters the boundary represented by the tile 712.

According to the present embodiment, the lawn mower 210 autonomously moves inside a work region 702 and a work region 722 included in a site 700, and cuts the lawn 12 that grows inside the work region 702 and the work region 722. The work region 702 and the work region 722 are connected by a path 710.

According to the present embodiment, the tile 712 is disposed in a boundary between the work region 702 and the path 710. A tile 714 is disposed in a boundary between the work region 722 and the path 710. The material and the irregularity pattern on the surface of the tile 712 are selected such that the state of the surface of the tile 712 is different from the states of the surfaces of the work region 702 and the path 710. The material and the irregularity pattern on the surface of the tile 714 are selected such that the state of the surface of the tile 714 is different from the states of the surfaces of the work region 722 and the path 710.

According to the present embodiment, a boundary 706 of the work region 702 separates the inside and the outside of the work region 702. A boundary 716 of the path 710 separates the inside and the outside of the path 710. A boundary 726 of the work region 722 separates the inside and the outside of the work region 722. A region located inside the site 700 and outside the work region 702, the path 710, and the work region 722 may be one example of the non-work region.

The boundary 706, the boundary 716, and the boundary 726 may be a boundary where the progress of the lawn mower 210 beyond the boundary is prohibited. On the other hand, the boundaries represented by the tile 712 and the tile 714 may be a boundary where the progress of the lawn mower 210 beyond the boundary is permitted. Thus, the user of the lawn mower 210 can restrict a field of activities of the lawn mower 210 to the inside of the work region 702, the path 710, and the work region 722.

In accordance with the present embodiment, the lawn mower 210 progresses straight ahead towards any orientation inside the work region 702, for example. When the lawn mower 210 approaches the boundary 706 of the work region 702, the lawn mower 210 detects the change of the vibration pattern. It is noted that in a case where the change of the vibration pattern is detected in the setting information 602, it may be set that until at least the analysis of the vibration pattern is ended, the progress is continued without changing the progress speed of the lawn mower 210. When the change of the vibration pattern is detected, the lawn mower 210 analyzes the vibration pattern, and decides the operation of the lawn mower 210.

In accordance with the present embodiment, the boundary 706 that separates the inside or the outside of the work region 702 indicates that the progress of the lawn mower 210 is prohibited in the region ahead of the boundary 706. There, the lawn mower 210 stops the progress, and makes a turn in the location. While the lawn mower 210 repeats the above-described operation, the lawn mower 210 passes over the tile 712. When the lawn mower 210 passes over the tile 712, the change judging section 510 detects the vibration pattern unique to the tile 712.

Herein, in accordance with one embodiment, when the lawn mower 210 moves on the path 710, the lawn mower 210 preferably interrupts the work. In addition, when the lawn mower 210 moves on the path 710, the lawn mower 210 preferably progresses straight ahead along an extending direction of the path 710.

In view of the above, the user creates the setting information 604 in which (i) the vibration pattern detected when the lawn mower 210 travels on the tile 712 is associated with (ii) the setting for the lawn mower 210 to interrupt the work and proceed in a direction substantially perpendicular to the boundary represented by the tile 712. The setting information 604 may also include information indicating the orientation or the bearing in the direction substantially perpendicular to the boundary represented by the tile 712. The setting information 604 may also include a setting related to the progress speed when the lawn mower 210 moves on the path 710. It is noted that different settings may also be specified depending on time slots.

Similarly, the user creates the setting information 604 in which (i) the vibration pattern detected when the lawn mower 210 travels on the tile 714 is associated with (ii) the setting for the lawn mower 210 to interrupt the work and proceed in a direction substantially perpendicular to the boundary represented by the tile 714. In addition, the user prepares the setting information 604 in which (i) the vibration pattern detected when the lawn mower 210 travels on the lawn 12 is associated with (ii) the setting for the lawn mower 210 to perform the lawn mowing work in the particular travel mode and at the work intensity.

In accordance with the present embodiment, when the change judging section 510 detects the vibration pattern unique to the tile 712, the change judging section 510 decides that the progress direction is changed to a direction corresponding to the direction substantially perpendicular to the boundary represented by the tile 712, and the direction from the work region 702 towards the work region 722. For example, the change judging section 510 changes the progress direction of the lawn mower 210 by the following procedures.

In accordance with the present embodiment, first, the fluctuation detection section 620 estimates an entry angle θ of the lawn mower 210 to the boundary represented by the tile 712. For example, according to the present embodiment, the vibration sensor 366 mainly detects the vibration of the front wheel 312 on the right side in the progress direction, and the vibration sensor 367 mainly detects the vibration of the front wheel 312 on the left side in the progress direction. In view of the above, as illustrated in FIG. 8 and FIG. 9, in a case where a progress direction F of the lawn mower 210 is inclined by the angle θ to an extending direction of the boundary represented by the tile 712 (indicated as an x direction in FIG. 8), a time difference dt occurs between a time when the particular vibration pattern is detected in the vibration data from the vibration sensor 366 and a time when the vibration pattern is detected in the vibration data from the vibration sensor 367.

As the above-described particular vibration pattern, (i) the vibration pattern detected when the lawn mower 210 runs on the tile 712, (ii) the vibration pattern detected when the lawn mower 210 travels on the tile 712, and the like are exemplified. It is noted that an extending direction of the boundary represented by the tile 712 is indicated as the x direction in FIG. 8. In addition, in FIG. 8, a y direction is a direction of a perpendicular line of the boundary represented by the tile 712.

According to the example illustrated in FIG. 9, when a vibration waveform 966 indicated by the vibration data output by the vibration sensor 366 is analyzed, it is possible to estimate the state of the ground in contact with the front wheel 312 on the right side in the progress direction. Similarly, when a vibration waveform 967 indicated by the vibration data output by the vibration sensor 367 is analyzed, it is possible to estimate the state of the ground in contact with the front wheel 312 on the left side in the progress direction.

For example, the fluctuation detection section 620 analyzes the vibration waveform 966, and detects a particular vibration pattern when the lawn mower 210 travels on the lawn 12 in a period at or before a time t12. In addition, the fluctuation detection section 620 detects a particular vibration pattern when the lawn mower 210 travels on the tile 712 in a period at or after a time t14. Furthermore, the fluctuation detection section 620 detects a particular vibration pattern when the lawn mower 210 climbs over a step in a period from the time t12 to t14.

Similarly, the fluctuation detection section 620 analyzes the vibration waveform 967, and detects a particular vibration pattern when the lawn mower 210 travels on the lawn 12 in a period at and before a time t22. In addition, the fluctuation detection section 620 detects a particular vibration pattern when the lawn mower 210 travels on the tile 712 in a period at and after a time t₂₄. Furthermore, the fluctuation detection section 620 detects a particular vibration pattern when the lawn mower 210 climbs over the step in a period from the time t22 to a time t24.

Herein, when a distance between the two front wheels 312 is set as W [m], a progress speed of the lawn mower 210 is set as v [m/s], and an absolute value of the time difference between the time t12 and the time t22 is set as dt [s], the following numeric expression (1) is established. It is noted that dt may also be an absolute value of the time difference between the time t14 and the time t24.

tan θ=W/(v×dt) (1)

Since the distance W between the two front wheels 312 is already known, by using the numeric expression (1), the fluctuation detection section 620 can calculate the entry angle θ of the lawn mower 210 to the boundary represented by the tile 712 on the basis of the progress speed v of the lawn mower 210 and the time difference dt at which the same vibration pattern is detected in the vibration waveform 966 and the vibration waveform 967. The fluctuation detection section 620 transmits the information indicating that the change of the vibration pattern is detected, the information indicating that the particular vibration pattern is detected when the lawn mower 210 travels on the tile 712, and the information indicating the entry angle θ of the lawn mower 210 to the setting extraction section 630.

Next, the setting extraction section 630 refers to the setting information 604, and extracts the setting related to the operation of the lawn mower 210 associated with the particular vibration pattern when the lawn mower 210 travels on the tile 712 in the setting information 604. As described above, in the setting information 604, (i) the vibration pattern detected when the lawn mower 210 travels on the tile 712 is associated with (ii) the setting in which the lawn mower 210 interrupts the work, and progresses in substantially the perpendicular direction to the boundary represented by the tile 712.

There, the setting extraction section 630 judges whether the entry angle θ of the lawn mower 210 is substantially perpendicular. In a case where the entry angle θ of the lawn mower 210 is substantially perpendicular, the setting extraction section 630 decides that the work mode of the lawn mower 210 is to be changed. On the other hand, in a case where the entry angle θ of the lawn mower 210 is not substantially perpendicular, the setting extraction section 630 decides that the progress direction and the work mode of the lawn mower 210 are to be changed. The setting extraction section 630 transmits information indicting the decision result to the judgement result generation section 640.

A judgement reference as to whether the entry angle θ of the lawn mower 210 is substantially perpendicular (for example, a numeric value range of the entry angle θ) may be decided on the basis of a width, a length, and a shape of the path 710. The above-described determination reference is decided, for example, such that while the lawn mower 210 passes through the path 710, the number of the lawn mower 210 to come into contact with the boundary 716 satisfies (i) a condition of being equal to or less than a predetermined threshold, (ii) a condition of being less than the predetermined threshold, or (iii) a condition of being the minimum (including zero times).

Next, the judgement result generation section 640 generates information indicating the judgement result. The judgement result generation section 640 transmits the information indicating the judgement result to the travel control section 420 and the work unit control section 430, for example. The information indicating the judgement result includes, for example, information indicating that the progress direction of the lawn mower 210 is to be changed, information indicating the progress direction after the change, and information indicating that the work is to be interrupted. The information indicating the judgement result may also include the information indicating the entry angle θ of the lawn mower 210. The information indicating the progress direction after the change may also be information indicating the determination reference for being the substantially perpendicular, or may also be information indicating the orientation or the bearing.

When the information indicating that the progress direction is to be changed is received, the travel control section 420 controls the travel motor 316, and changes the progress direction of the lawn mower 210. According to one embodiment, the travel control section 420 decides a turning angle of the lawn mower 210 on the basis of the information indicating the determination reference for being the substantially perpendicular and the information indicating the entry angle θ of the lawn mower 210. According to another embodiment, the travel control section 420 decides the turning angle of the lawn mower 210 such that the progress direction of the lawn mower 210 becomes the orientation or the bearing indicated by the information indicating the judgement result. According to still another embodiment, the travel control section 420 repeats turning of the lawn mower 210 in the vicinity of the tile 712 until the above-described time difference dt is equal to or lower than the predetermined threshold, or until the above-described time difference dt is lower than the predetermined threshold.

When the information indicating that the work is to be interrupted is received, the work unit control section 430 stops the work motor 326. In addition, the work unit control section 430 operates the location adjustment section 330 to lift the work unit 320.

In accordance with the present embodiment, the lawn mower 210 can autonomously travel inside the work region 702 and the work region 722 in accordance with a predetermined the travel mode. In addition, the lawn mower 210 can cut the lawn 12 inside the work region 702 and the work region 722 in accordance with the predetermined the work mode. Furthermore, by using the tile 712 or the tile 714, the user can control the operation of the lawn mower 210 at the spot where the tile 712 or the tile 714 is disposed.

In addition, according to the present embodiment, the operation of the lawn mower 210 is decided on the basis of the vibration of the lawn mower 210. For this reason, as compared with a case where the lawn mower 210 detects the boundary using the buried wire, it is possible to save trouble for installing the wire. In addition, even in a case where a part of a region of the boundary is damaged, the lawn mower 210 can detect another region of the boundary. Furthermore, even in a case where the map information indicating the location of the boundary is not completed or a case where the map information is absent, the lawn mower 210 can detect the boundary.

According to the present embodiment, the case has been described where the setting extraction section 630 refers to the setting information 604, and decides the operation of the lawn mower 210 at the spot where the tile 712 is disposed. However, the method of deciding the operation of the lawn mower 210 inside the work region 202 or at the particular spot on the boundary 706 is not limited to the present embodiment.

According to another embodiment, the setting extraction section 630 uses the map information in which the information indicating the location inside the work region 202 or the particular spot or region on the boundary 706 is associated with the information indicating the setting related to the operation of the lawn mower 210 at the particular spot or region, and decides the operation of the lawn mower 210 at the particular spot inside the work region 202 or on the boundary 706. For example, the setting extraction section 630 obtains the information indicating the estimated location of the lawn mower 210, and refers to the map information to decide the operation of the lawn mower 210 in the estimated location. According to still another embodiment, the setting extraction section 630 may also decide the operation of the lawn mower 210 inside the work region 202 or the particular spot on the boundary 706 by using the vibration data and the map information.

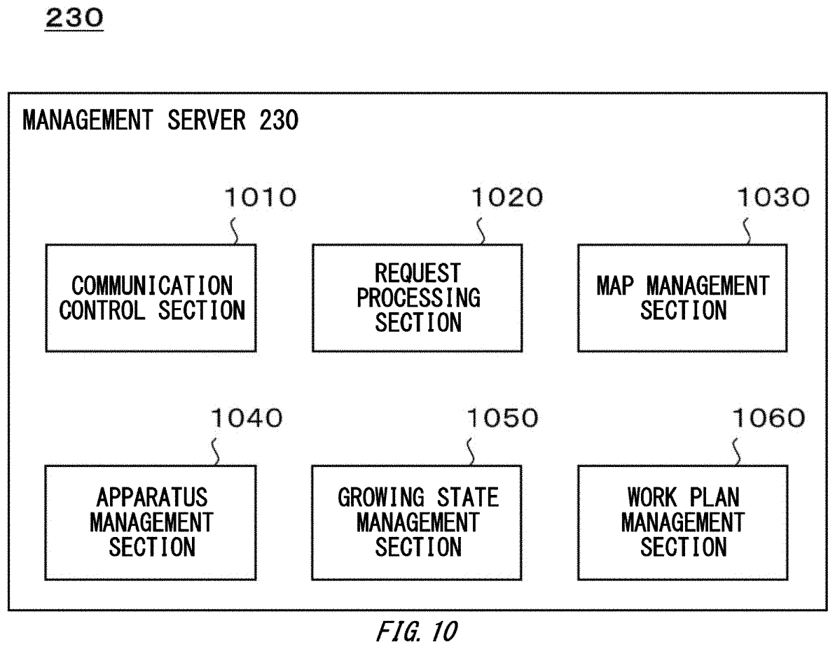

FIG. 10 schematically illustrates one example of an internal configuration of the management server 230. According to the present embodiment, the management server 230 includes a communication control section 1010, a request processing section 1020, a map management section 1030, an apparatus management section 1040, a growing state management section 1050, and a work plan management section 1060.

According to the present embodiment, the communication control section 1010 controls a communication with an external apparatus of the management server 230. The communication control section 1010 may also be a communication interface compatible to one or a plurality of communication methods. As the external apparatus, the user terminal 22, the lawn mower 210, and the like are exemplified. According to the present embodiment, the request processing section 1020 accepts a request from an external apparatus. The request processing section 1020 processes the request from the external apparatus.

According to the present embodiment, the map management section 1030 manages the map information. For example, the map management section 1030 executes processing such as generation, update, deletion, and search of the map information. According to one embodiment, the map management section 1030 manages the map information of all the sub areas 204 included in the work region 202. According to another embodiment, with regard to a part of the sub areas 204 among the sub areas 204 included in the work region 202, the map management section 1030 manages the map information of the sub areas. A detail of the map management section 1030 will be described below.

According to the present embodiment, the apparatus management section 1040 manages various apparatuses constituting the management system 200. For example, the apparatus management section 1040 controls the lawn mower 210. The apparatus management section 1040 may also manage the information related to the various apparatuses associated with the management system 200. For example, the apparatus management section 1040 obtains the information related to the state of the lawn mower 210 from the lawn mower 210. The apparatus management section 1040 may also manage the information related to the user terminal 22.

According to the present embodiment, the growing state management section 1050 manages the information related to the growing state of the lawn 12. The growing state management section 1050 may also manage the information related to the growing state of the lawn 12 in each of the plurality of sub areas 204 included in the work region 202. the growing state management section 1050 may also manage the information related to the growing state of the lawn 12 in at least one of the plurality of sub areas 204 included in the work region 202.

As the growing state of the lawn 12, a growing stage of the lawn 12, a growing situation of the lawn 12, and the like are exemplified. As information indicating the growing situation of the lawn 12, a color of the lawn 12, a thickness of the lawn 12, a density of the lawn 12, and the like are exemplified. It is conceivable that as the lawn 12 grows more, a load of the work unit 320 is further increased. In view of the above, the information indicating the growing situation of the lawn 12 may also be information indicating the load of the work unit 320. As the load of the work unit 320, a load of the work motor 326, a wear-out degree of the cutter blade 324, and the like are exemplified.

The growing state management section 1050 may also manage information related to a growing environment of the lawn 12. As the growing environment of the lawn 12, information related to the soil of the sub area 204, and the like are exemplified.

According to the present embodiment, the work plan management section 1060 manages the schedule of the work to be performed by the lawn mower 210 (which may be referred to as a work schedule in some cases). The work plan management section 1060 may plan the schedule of the work to be performed in the sub area with regard to each of the plurality of sub areas 204 included in the work region 202. The work plan management section 1060 may plan the work schedule of the lawn mower 210. The work plan management section 1060 may manage the progress of the work schedule of the lawn mower 210.

The work schedule may be information in which (i) the identification information indicating each of the plurality of sub areas 204, (ii) the timing when the work related to growing of the lawn 12 is performed in the sub area, and (iii) at least one of the type and the intensity of the work in the sub area are associated with one another. The type of the work may be at least one of sowing, pruning, lawn mowing, grass cutting, watering, fertilizing, soiling, and weeding. The work plan management section 1060 may also update the work schedule on the basis of the information obtained by the growing state management section 1050.

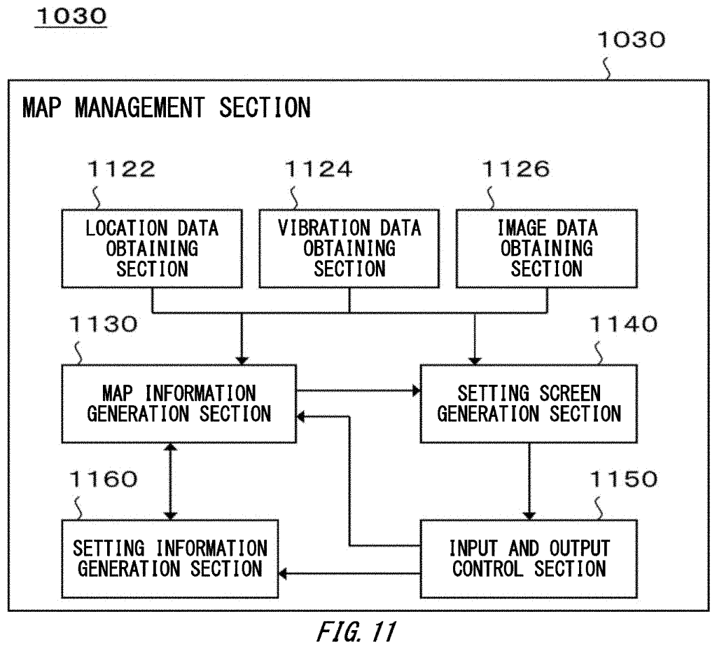

FIG. 11 schematically illustrates one example of an internal configuration of the map management section 1030. According to the present embodiment, the map management section 1030 includes a location data obtaining section 1122, a vibration data obtaining section 1124, an image data obtaining section 1126, a map information generation section 1130, a setting screen generation section 1140, an input and output control section 1150, and a setting information generation section 1160.

The map management section 1030 may be one example of a surrounding information obtaining section. The vibration data obtaining section 1124 may be one example of the surrounding information obtaining section. The map information generation section 1130 may be one example of a control information generation section. The input and output control section 1150 may be one example of an instruction acceptance section. The setting information generation section 1160 may be one example of the control information generation section.

According to the present embodiment, the location data obtaining section 1122 obtains the information indicating the estimated location of the lawn mower 210. The location data obtaining section 1122 may also obtain the information in which the information indicating the time is associated with the information indicating the estimated location of the lawn mower 210 at the time.

The information indicating the estimated location of the lawn mower 210 may also be included in the output data of the sensor unit 370. The location data obtaining section 1122 may also calculate the estimated location of the lawn mower 210 on the basis of the output data of the internal sensor of the sensor unit 370. The location data obtaining section 1122 may also calculate the estimated location of the lawn mower 210 on the basis of the output data of the external sensor of the sensor unit 370. The location data obtaining section 1122 may also calculate the estimated location of the lawn mower 210 on the basis of the output data of the image capturing unit 364.

According to the present embodiment, the vibration data obtaining section 1124 obtains the information related to the vibration of the lawn mower 210. For example, the vibration data obtaining section 1124 obtains the vibration data output by the vibration sensor 366. The vibration data obtaining section 1124 may also obtain the vibration data output by the vibration sensor 366. The vibration data obtaining section 1124 may also obtain the information in which the information indicating the time is associated with the information related to the vibration of the lawn mower 210 at the time. The vibration data obtaining section 1124 may also obtain the information in which the information indicating the estimated location of the lawn mower 210 is associated with the information related to the vibration of the lawn mower 210 in the estimated location.

According to the present embodiment, the image data obtaining section 1126 obtains image data of the image of the surrounding of the lawn mower 210. For example, the image data obtaining section 1126 obtains image data of the image captured by the image capturing unit 364. The image data obtaining section 1126 may obtain the information in which the information indicating the time is associated with the image data of the image captured at the time. The image data obtaining section 1126 may also obtain the information in which the information indicating the estimated location of the lawn mower 210 is associated with the image data of the image captured in the estimated location.

According to the present embodiment, the image data of the image that captures the situation of the surrounding of the lawn mower 210 is associated with at least one of the information indicating the image capturing time and the information indicating the image capturing location. In addition, the vibration data is associated with at least one of the information indicating the vibration detection time and the information indicating the vibration detection location. Thus, the location where the vibration is detected may be associated with the location where the image data is captured. The information in which the image data is associated with at least one of the information indicating the image capturing time and the information indicating the image capturing location may be one example of the surrounding information.

According to the present embodiment, the map information generation section 1130 generates various map information. The map information generation section 1130 may also generate the map information in cooperation with the setting screen generation section 1140 and the input and output control section 1150. The map information may be one example of the control information.

As the map information, (i) information indicating the location of the boundary, (ii) information in which the information indicating the location of the particular spot or region on the boundary is associated with the information indicating the vibration pattern at the particular spot or region, (iii) information in which the information indicating the location of the particular spot or region on the boundary is associated with the information indicating the type of the boundary at the particular spot or region, (iv) information in which the information indicating the location of the particular spot or region on the boundary the information indicating the vibration pattern at the particular spot or region, and the information indicating the type of the boundary at the particular spot or region are associated with one another, (v) information in which the information indicating the location inside the work region 202 or at the particular spot or region on the boundary is associated with each other the information indicating the setting related to the operation of the lawn mower 210 at the particular spot or region, (vi) information in which the information indicating the location of the particular spot or region on the boundary, the information indicating the vibration pattern at the particular spot or region, and the information indicating the setting related to the operation of the lawn mower 210 at the particular spot or region are associated with one another, and the like are exemplified.

According to the present embodiment, the map information generation section 1130 obtains the information, from the location data obtaining section 1122, in which the information indicating the time is associated with the information is associated with the information indicating the estimated location of the lawn mower 210 at the time. The map information generation section 1130 obtains the information, from the vibration data obtaining section 1124, in which the information indicating the time is associated with the information related to the vibration of the lawn mower 210 at the time, for example. The map information generation section 1130 obtains the information, from the image data obtaining section 1126, in which the information indicating the time is associated with the image data of the image captured at the time, for example.

According to the present embodiment, the map information generation section 1130 associates the estimated location of the lawn mower 210, the vibration of the lawn mower 210, and the image of the surrounding of the lawn mower 210 with one another by using the information indicating the time as a key, for example. Thus, the map information generation section 1130 can generate the map information in which the information indicating the location of the spot where the vibration is detected, the vibration data indicating the vibration waveform in a period around a point in time when the vibration is detected, and the image data indicating the situation of the surrounding in the period around the point in time when the vibration is detected are associated with one another.

The map information generation section 1130 outputs the above-described map information to the setting screen generation section 1140. The above-described map information is used in the processing for the user to specify the setting related to the operation of the lawn mower 210. The map information generation section 1130 obtains, from the input and output control section 1150, the information indicating the operation of the lawn mower 210 indicated by the instruction accepted by the input and output control section 1150. Thus, the map information generation section 1130 can generate the map information in which the information indicating the location of the particular spot or region is associated with the information indicating the operation of the lawn mower 210 at the spot or region. The map information generation section 1130 can generate the map information in which the particular vibration pattern is associated with the information indicating the operation of the lawn mower 210 in a case where the vibration pattern is detected.

According to the present embodiment, the setting screen generation section 1140 generates a setting screen for the user to specify a setting related to the operation of the lawn mower 210. The setting screen generation section 1140 generates the setting screen for assisting a creation work of at least one of the setting information 602 and the setting information 604 by the user, for example.

The setting screen generation section 1140 may generate a screen for presenting at least a part of the map information generated by the map information generation section 1130 to the user. The setting screen generation section 1140 may also generate a screen for accepting an input from the user. For example, the setting screen generation section 1140 generates a screen including an input form for the user to specify the operation of the lawn mower 210. Thus, for example, the user (i) refers to a part of the image obtained by the image data obtaining section 1126 to understand the location of the lawn mower 210 or the situation of the surrounding of the lawn mower 210, and (ii) can specify the operation of the lawn mower 210 in the location. A detail of the setting screen will be described below.

According to the present embodiment, the input and output control section 1150 presents the setting screen generated by the setting screen generation section 1140 to the user. For example, the input and output control section 1150 transmits the data of the setting screen to the user terminal 22 in accordance with the request from the user terminal 22.

The setting screen includes, for example, a region for displaying at least a part of the map information generated by the map information generation section 1130. The map information includes the information indicating the location of the spot or region where the vibration is detected, and the image data of the image captured in the spot or region. The above-described image may be (i) a video image or (ii) one or a plurality of still images which are captured in a period having any length including the point in time when the above-described vibration is detected. The above-described region may be any of the sub areas 204. An input form for accepting the input of the user may also be provided on the setting screen.

According to the present embodiment, the input and output control section 1150 accepts the instruction related to the operation of the lawn mower 210 from the user. For example, the input and output control section 1150 accepts the instruction related to the operation of the lawn mower 210 in the location where the image data is captured from the user via the user terminal 22. The input and output control section 1150 may accept the instruction of the user by obtaining the information input to the input form provided on the above-described setting screen. The input and output control section 1150 may output the information input to the input form by the user to at least one of the map information generation section 1130 and the setting information generation section 1160.

According to the present embodiment, the setting information generation section 1160 generates the setting information in which the vibration pattern is associated with the setting related to the operation of the lawn mower 210. The setting information generation section 1160 may generate the above-described setting information on the basis of the information indicating the input from the user which has been obtained by the input and output control section 1150.

For example, the user (i) refers to the setting screen displayed on the display section of the user terminal 22, and (ii) inputs the operation of the lawn mower 210 in the particular spot or region to the input form provided on the setting screen. More specifically, first, the user operates the user terminal 22 to display the setting screen. The map information indicating the location of the spot or region where the vibration is detected is displayed on the setting screen. Next, the user operates the user terminal 22 to select one of the spots or regions where the vibration is detected.

Next, the user operates the user terminal 22 to specify the operation of the lawn mower 210 in the selected spot or region. The input and output control section 1150 obtains the information input by the user to the user terminal 22. The setting information generation section 1160 obtains the information indicating the spot or region specified by the user and the information indicating the operation of the lawn mower 210 in the spot or region from the input and output control section 1150.

On the other hand, as described above, the setting information generation section 1160 obtains, from the vibration data obtaining section 1124, the information in which the information indicating at least one of the location and the time at which the vibration is detected is associated with the information indicating the vibration pattern of the vibration. The setting information generation section 1160 matches the information obtained from the vibration data obtaining section 1124 with the information obtained from the input and output control section 1150 to associate the information indicating the vibration pattern included in the information obtained from the vibration data obtaining section 1124 with the information indicating the operation of the lawn mower 210 included in the information obtained from the input and output control section 1150. Thus, the setting information 604 is generated.

It is noted that in a case where the setting information generation section 1160 obtains, from the vibration data obtaining section 1124, the information in which the time when the information indicating that the vibration is detected is associated with the information indicating the vibration pattern of the vibration, the setting information generation section 1160 obtains the information indicating the time and the information indicating the estimated location of the lawn mower 210 at the time from the location data obtaining section 1122. The setting information generation section 1160 may generate information in which the location where the information indicating that the vibration is detected is associated with the information indicating the vibration pattern of the vibration on the basis of the information obtained from the location data obtaining section 1122 and the information obtained from the vibration data obtaining section 1124. The setting information generation section 1160 may generate the setting information 604 by using the information in which the location where the information indicating that the vibration is detected is associated with the information indicating the vibration pattern of the vibration.

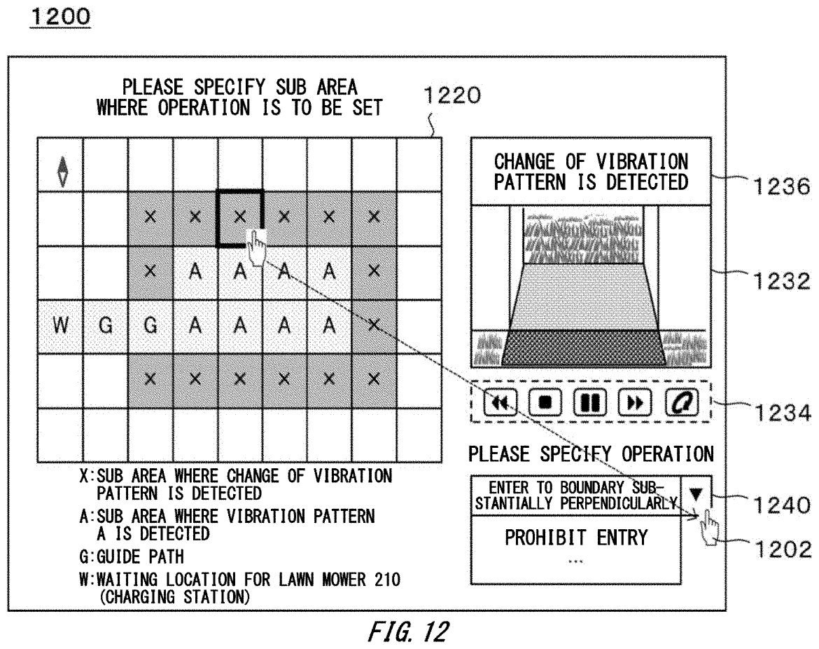

FIG. 12 schematically illustrates one example of a setting screen 1200. According to the present embodiment, the setting screen 1200 includes a map display section 1220, an image display section 1232, a reproduction control section 1234, a message display section 1236, and a setting input section 1240.

The map display section 1220 displays at least a part of the map information of the work region 202. The map display section 1220 may display the map information related to a part of the work region 202. The map display section 1220 may change a region to be displayed on the map display section 1220 following the instruction of the user. The map display section 1220 may display a part of the information related to the work region 202.

The map information is generated, for example, by the map information generation section 1130. The map information may display a location of one or a plurality of spots or regions where the vibration is detected corresponding to spots or regions inside the work region 202 or on the boundary 206. The map information may also display a location of one or a plurality of spots or regions where the vibration is not detected corresponding to spots or regions inside the work region 202 or on the boundary 206.

The map display section 1220 may accept the instruction of the user to the spot or region displayed on the map display section 1220. The information input to the map display section 1220 may be transmitted to the input and output control section 1150. For example, the user operates the user terminal 22 to move a pointer 1202 on the setting screen 1200, and selects any spot or region. The map display section 1220 accepts the selection instruction by the user. Thus, the user can execute any operation or processing for the spot or region selected by the user, for example.

According to the present embodiment, the image display section 1232 displays an image captured at the spot or region selected by the user. The above-described image may be an image captured by the image capturing unit 364 in a period having a predetermined duration including the point in time when the vibration is detected. The image display section 1232 may be an image of the surrounding of the spot or region selected by the user. Thus, the user can browse, for example, an image of a surrounding of any spot or region corresponding to an image of 10 seconds around a point in time when the vibration is detected. The above-described image may also be a video image, or may also be a still image. Thus, while the above-described image is browsed, the user can decide the operation of the lawn mower 210 at the spot or region.

According to the present embodiment, the reproduction control section 1234 accepts, from the user, an instruction for controlling reproduction processing of the image displayed on the image display section 1232. As the control method of the reproduction processing, start of the reproduction, stopping, pausing, resumption of the reproduction, fast-forwarding, rewinding, change of a point of view, and the like are exemplified. For example, when the user operates an icon for changing the point of view while an image of a front view of the lawn mower 210 is displayed, an image of a left front view of the lawn mower 210 is displayed, an image of a right front view of the lawn mower 210 is displayed, an image of an upper front view of the lawn mower 210 is displayed, or an image of a lower front view of the lawn mower 210 is displayed according to the operation by the user.

According to the present embodiment, the message display section 1236 displays a message related to the image displayed on the image display section 1232. The message display section 1236 may display a message according to a reproduction location of the image displayed on the image display section 1232. Information indicating the contents of the above-described message may also be stored in the storage section 460 while being associated with identification information of a frame of the video image.

According to the present embodiment, the setting input section 1240 accepts an input of the information indicating the setting related to the operation of the lawn mower 210 from the user. For example, the setting related to the operation of the lawn mower 210 at the spot or region selected by the user is input to the setting input section 1240. The information input to the setting input section 1240 may be transmitted to the input and output control section 1150.

While the embodiments of the present invention have been described, the technical scope of the invention is not limited to the above described embodiments. It is apparent to persons skilled in the art that various alterations and improvements can be added to the above-described embodiments. In addition, as long as a technical contradiction is not made, items described with regard to a particular embodiment can be applied to another embodiment. For example, an item described with regard to the embodiment of FIG. 1 may be applied to another embodiment described in relation with another drawing. It is also apparent from the description of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the operation flow is described using phrases such as “first” or “next” in the claims, embodiments, or diagrams, it does not necessarily mean that the process must be performed in this order. EXPLANATION OF REFERENCES

10 plant, 12 lawn, 18 boundary identification member, 20 communication network, 22 user terminal, 102 work region, 104 non-work region, 106 boundary, 150 work machine, 160 vibration detection section, 180 control apparatus, 182 vibration information obtaining section, 184 boundary detection section, 186 control section, 200 management system, 202 work region, 204 sub area, 206 boundary, 208 tile, 210 lawn mower, 230 management server, 302 enclosure, 311 axle, 312 front wheel, 313 suspension apparatus, 314 rear wheel, 316 travel motor, 317 axle, 318 suspension apparatus, 320 work unit, 322 blade disk, 324 cutter blade, 326 work motor, 328 shaft, 330 location adjustment section, 340 battery unit, 350 user interface, 364 image capturing unit, 366 vibration sensor, 367 vibration sensor, 370 sensor unit, 380 control unit, 410 communication control section, 420 travel control section, 430 work unit control section, 440 input and output control section, 450 control parameter decision section, 460 storage section, 510 change judging section, 520 parameter decision section, 522 progress direction decision section, 524 progress speed decision section, 526 travel mode decision section, 528 work mode decision section, 602 setting information, 604 setting information, 610 vibration pattern extraction section, 620 fluctuation detection section, 630 setting extraction section, 640 judgement result generation section, 700 site, 702 work region, 706 boundary, 710 path, 712 tile, 714 tile, 716 boundary, 722 work region, 726 boundary, 966 vibration waveform, 967 vibration waveform, 1010 communication control section, 1020 request processing section, 1030 map management section, 1040 apparatus management section, 1050 growing state management section, 1060 work plan management section, 1122 location data obtaining section, 1124 vibration data obtaining section, 1126 image data obtaining section, 1130 map information generation section, 1140 setting screen generation section, 1150 input and output control section, 1160 setting information generation section, 1200 setting screen, 1202 pointer, 1220 map display section, 1232 image display section, 1234 reproduction control section, 1236 message display section, 1240 setting input section

What is claimed is:

1. A control apparatus that controls a work machine having an autonomous travel function, the control apparatus comprising:
a vibration information obtaining section configured to obtain, from a vibration detection section mounted to the work machine, vibration information related to vibration detected by the vibration detection section; and
a control section configured to control at least one of a progress direction, a progress speed, a travel mode, and a work mode of the work machine based on the vibration information obtained by the vibration information obtaining section.

2. The control apparatus according to claim 1, wherein
the control section has a command output section configured to output a command for changing at least one of the progress direction, the progress speed, the travel mode, and the work mode of the work machine (i) in a case where a vibration pattern indicated by the vibration information obtained by the vibration information obtaining section is changed from a vibration pattern characteristic to a work region of the work machine to a vibration pattern characteristic to a non-work region of the work machine, (ii) in a case where the vibration pattern characteristic to the work region of the work machine disappears, or (iii) in a case where the vibration pattern indicated by the vibration information obtained by the vibration information obtaining section is changed from the vibration pattern characteristic to the non-work region to the vibration pattern characteristic to the work region.

3. The control apparatus according to claim 1, wherein
the control section has:
an extraction section configured to refer to information in which each of predetermined one or more of vibration patterns is associated with an operation of the work machine, and extract the operation of the work machine which is associated with a vibration pattern matched with the vibration pattern indicated by the vibration information obtained by the vibration information obtaining section among the predetermined one or more of vibration patterns, and
a command output section configured to output a command for controlling at least one of the progress direction, the progress speed, the travel mode, and the work mode of the work machine based on contents of the operation of the work machine which is extracted by the extraction section.

4. The control apparatus according to claim 1, further comprising:
a boundary detection section configured to detect a boundary between the work region and the non-work region of the work machine based on the vibration information obtained by the vibration information obtaining section, wherein
the control section has a command output section configured to output a command for changing at least one of the progress direction, the progress speed, the travel mode, and the work mode of the work machine in a case where the boundary detection section detects the boundary.

5. A control apparatus that controls a work machine having an autonomous travel function, the control apparatus, comprising:
a vibration information obtaining section configured to obtain, from a vibration detection section mounted to the work machine, vibration information related to vibration detected by the vibration detection section; and
a boundary detection section configured to detect a boundary between a work region and a non-work region of the work machine based on the vibration information obtained by the vibration information obtaining section.

6. The control apparatus according to claim 4, wherein
the boundary detection section detects the boundary between the work region and the non-work region (i) in a case where a vibration pattern indicated by the vibration information obtained by the vibration information obtaining section is changed from a vibration pattern characteristic to the work region to a vibration pattern characteristic to the non-work region, (ii) in a case where the vibration pattern characteristic to the work region of the work machine disappears, or (iii) in a case where the vibration pattern indicated by the vibration information obtained by the vibration information obtaining section is changed from the vibration pattern characteristic to the non-work region to the vibration pattern characteristic to the work region.

7. The control apparatus according to claim 6, wherein
the boundary detection section judges whether progress may be continued based on the vibration information obtained by the vibration information obtaining section (i) in a case where the vibration pattern indicated by the vibration information obtained by the vibration information obtaining section is changed from the vibration pattern characteristic to the work region to the vibration pattern characteristic to the non-work region, or (ii) in a case where the vibration pattern characteristic to the work region of the work machine disappears.

8. The control apparatus according to claim 7, further comprising:
a change decision section configured to decide that at least one of the progress direction, the progress speed, the travel mode, and the work mode of the work machine is to be changed based on at least one of a detection result and a judgement result of the boundary detection section.

9. The control apparatus according to claim 8, wherein
in a case where the boundary detection section judges that the progress may be continued, the change decision section decides that the progress direction is to be changed such that the work machine progresses in a substantially perpendicular direction to the boundary.

10. The control apparatus according to claim 8, wherein
in a case where the boundary detection section judges that the progress is not to be continued, the change decision section decides that the progress direction is to be changed such that the work machine progresses towards an inside of the work region.

11. The control apparatus according to claim 4, wherein:
the vibration detection section of the work machine includes a first vibration detection section and a second vibration detection section that are disposed in different locations in the work machine;
the vibration information obtaining section obtains first vibration information related to vibration detected by the first vibration detection section, and second vibration information related to vibration detected by the second vibration detection section; and
the boundary detection section estimates an entry angle of the work machine to the boundary based on the first vibration information and the second vibration information.

12. The control apparatus according to claim 1, further comprising:
a surrounding information obtaining section configured to obtain (i) image data of an image of a surrounding of the work machine, and (ii) surrounding information including information for associating a location where the vibration is detected with a location where the image is captured;
an instruction acceptance section configured to (i) present, to a user, a screen in which the location where the vibration is detected is associated with the image in the location based on the surrounding information obtained by the surrounding information obtaining section, and (ii) accept, from the user, an instruction related to an operation of the work machine in the location where the image data is captured; and
a control information generation section configured to generate control information in which the operation of the work machine indicated by the instruction accepted by the instruction acceptance section is associated with the vibration pattern indicated by the vibration information obtained by the vibration information obtaining section.

13. A non-transitory computer-readable storage medium that stores a program of a control apparatus that controls a work machine having an autonomous travel function,
the program causing a computer to execute:
a vibration information obtaining procedure to obtain, from a vibration detection device mounted to the work machine, vibration information related to vibration detected by the vibration detection device; and
a controlling procedure to control at least one of a progress direction, a progress speed, a travel mode, and a work mode of the work machine based on the vibration information obtained in the vibration information obtaining procedure.

14. A work machine which is configured to autonomously travel, comprising:
the control apparatus according to claim 1; and
the vibration detection section.

15. The work machine according to claim 14, wherein
the vibration detection section is disposed in at least one of (i) a vehicle body, (ii) a wheel or a continuous track, (iii) an axle, and (iv) a suspension apparatus of the work machine.
